(19) United States
(12) Patent Application Publication
(10) Pub. No.: US 2016/0060434 A1
(43) Pub. Date: Mar. 3, 2016

(54) STABILIZATION OF POLYAMIDE WITH COPPER-BASED METAL ORGANIC FRAMEWORKS

(71) Applicant: BASF SE, Ludwigshafen (DE)

(72) Inventors: Roger REINICKER, Hockessin (DE); Stefan MAURER, Ludwigshafen (DE); Ulrich MUELLER, Neustadt (DE)

(73) Assignee: BASF SE, Ludwigshafen (DE)

(21) Appl. No.: 14/783,531

(22) PCT Filed: Apr. 7, 2014
(86) PCT No.: PCT/EP14/56920

§ 371 Date: Oct. 9, 2015

(30) Foreign Application Priority Data
Apr. 9, 2013 (EP) 13162842.2

(51) Int. Cl. C08K 5/56

(52) U.S. Cl. CPC C08K 5/56

(57) ABSTRACT

The invention relates to a method for manufacturing of a stabilized polyamide-containing composition, which contains at least 20% by weight of polyamide, which comprises the steps of incorporating of a metal organic framework, which is a copper-based metal organic framework comprising metal ions, which are copper(II)-ions, and a C₆-C₂₄ aromatic hydrocarbon, which is substituted with at least two carboxylate groups, wherein two of the at least two carboxylate groups are forming coordinative bonds to the metal ions, into a polyamide-containing composition, which contains at least 20% by weight of polyamide, to obtain a mixture for molding, which contains at least 20% by weight of polyamide; and heating of the obtained mixture for molding comprising the polyamide-containing composition and the metal organic framework to a temperature between 170° C. and 380° C.

The present invention relates to a method for manufacturing of a stabilized polyamide-containing composition, a mixture for molding as an intermediate of the method for manufacturing, the resulting stabilized polyamide-containing composition, a shaped article thereof and an use of copper-based metal organic frameworks for stabilization of a polyamide-containing composition against degradation by heat, light or oxygen.

Polyamide is susceptible to degradation, which can be induced by heat, light and/or oxidation. The degree of degradation of a polyamide can be determined by measurement of its coloration, its mechanical properties, its behaviour in hydrolysis studies or its bleeding properties in liquid environments. For reducing degradation, numerous solutions in regard to an incorporation of a stabilizer are proposed.

Metal salts, for example manganese salts and copper salts, are often employed as stabilizers of polyamide. Copper salts are preferred as thermal stabilizers, especially for improving the thermal aging resistance. Furthermore, the combination of copper salts with alkali halide salts is recommended.

GB 722724 discloses that polyamide stabilization by copper salts is improved if a halogen compound from the group consisting of hydrogen halide acids, alkali metal halides, alkaline-earth metal halides and ammonium halide is added. In the examples, copper(II) acetate is the preferred copper salt.

GB 1298055 discloses bis(aryleneotriazole)diphenyl-2,2′-dicarboxylic acid derivatives, which are converted to their copper salts and afterwards applied as heat stabilizers to polyamide.

EP-A-0261821 discloses the stabilization of polyamide fibers with copper salts, wherein the copper salts are applied to a fibrous fabric in combination with a dye out of aqueous liquor. The fabric is contacted with the liquid and the wet fabric treated at 100° C. in a steamer. EP-A-02618821 discloses the preparation of aqueous solutions comprising copper salts obtained by mixing of cupric sulphate and the appropriate sodium salt by direct double decomposition precipitation. Copper salts with aromatic carboxylic acids prepared by this way are copper benzoate, copper 4-nitrobenzoate, copper anthranilate and copper 2-naphthoate.

U.S. Pat. No. 3,280,053 discloses inter alia the stabilization of polyamide, wherein molten ε-caproIactam at 80° C. is treated with cupric salicylate tetrahydrate dissolved in water, followed by stannous chloride as polymerization catalyst. After heating to finally 255° C. for 13 hours, the molten polyamide was extruded and processed to pellets. A molded article shows under oven aging improved mechanical properties versus the same molded article prepared without stannous chloride and thus solely with copper salicylate.

U.S. Pat. No. 3,457,325 discloses the heat stabilization of synthetic linear polyamide fibers with copper isophthalate, copper orthophthalate or copper terephthalate in combination with an alkali metal iodide. Copper isophthalate is prepared by a precipitation reaction between sodium isophthalate and cupric chloride. The precipitate and potassium iodide are added during the polymerization of aqueous hexamethylene diammonium adipate with a final temperature of 195° C. Finally, yarn is produced in a spinneret from the received polymer with a copper content of 60 ppm and samples thereof are placed in a forced air oven at 180° C. This leads to better mechanical properties versus copper 8-hydroxyquinolate. It is observed at copper orthophthalate that in the absence of the potassium iodide, the copper compound decomposes to give the polyamide an undesirable blue violet colour.

U.S. Pat. No. 3,499,867 discloses the heat stabilization of a polyamide composition, which comprises a pre-formed copper complex prepared by heating a divalent copper salt at a temperature of from 100° C. to 140° C. with a lactam moiety having from 5 to about 12 carbon atoms or an amino-substituted aliphatic carboxylic acid containing from about 5 to about 12 carbon atoms.

U.S. Pat. No. 5,371,132 discloses the stabilization of a polyamide with a combination of a copper compound, an iodide compound and/or a manganese compound. Proposed carboxylate type of copper salts are copper stearate, copper montanate, copper adipate, copper isophthalate, copper terephthalate, copper benzoate and copper acetate. It is stated that the iodine compound is added in such an amount that the gram ratio of iodine element and copper element ([iodine/copper]) is 20 to 30. If it is less than 20, sufficient thermal aging resistance and light resistance cannot be obtained and furthermore, post-colouration of the resin due to absorption of water is conspicuous.

US-A-2009/0142585 discloses a polyamide composition, which comprises a copper species selected from Cu(I), Cu(II) or a mixture thereof. Specific mentioned copper compounds, which are carboxylate salts, are copper acetate, copper naphthenate, copper caprate, copper laurate and copper stearate. In the examples, a commercial heat stabilizer mixture consisting of 7 parts potassium iodide, 1 part copper(I) iodide and 1 part aluminium distearate is employed.

US-A-2011/0028614 discloses a polyamide composition comprising a copper compound and a metal halide. Examples of copper compounds are copper halide, copper acetate, copper proprionate, copper benzoate, copper adipate, copper terephthalate, copper isophthalate, copper salicylate, copper nicotinate, copper stearate and copper complex salts coordinated to a chelating agent such as ethylenediamine and ethylene-diaminetetraacetic acid. It is stated that the preferred molar ratio of copper to halogen is below 0.5 or less, because then copper precipitation and metal corrosion—described as metal corrosion of the screw and cylinder of the extruder during extrusion—can be suppressed. It is also stated that blending of the copper compound and the metal halide improves the performance of the polyamide composition. Also disclosed are blends of potassium iodide and copper iodide, which comprise ethylene bis-stearylamide as binding agent for the generation of pellets.

US-A-2011/0039993 discloses in regard to polyamide stabilization in its examples that the combination of copper(I)-oxide and potassium bromide results in better stabilization than copper(I)-oxide alone or a combination of copper(I)-iodide and potassium iodide. Thereby, more bromide or iodide than copper is employed in the combinations.

WO-A-2009/092494 discloses compositions, which contain at least one polymer and a light stabilizer additive component which is distributed in solid form within the polymer and comprises a metal-organic framework. Said metal-organic framework material comprises at least one bidentate organic aromatic compound bound coordinatively to at least one metal ion. Out of many possibilities, the organic aromatic compound can be inter alia terephthalic acid, isophthalic acid, 2,6-napthalenedicarboxylic acid or 1,3,5-benzenetricarboxylic acid. Out of many possibilities, copper is mentioned as a possible metal ion. Out of many possibilities, polyamide is mentioned as one possible polymer.

WO-A-2010/106105 describes the use of metal organic frameworks in a biodegradable material, which comprises a polymer, in the form of a film or a foil for absorbing ethene in foodstuff packaging.

The current solutions do not satisfy in each aspect todays stabilization requirements. There is still a need for an improved stabilization of polyamide, which provides durability under heating, under exposure to light and/or under exposure to oxygen. While a good stabilization is desired, the conduction of the stabilization should also be economic in regard to the amount of the employed stabilizer and in regard to the required process. The latter comprises topics like ease of incorporation of the stabilizer, e.g. simple dosing into the polyamide including low dust generation, few to no pre-treatment steps like milling prior to dosing or no requirement for preparation of pre-formulations in case of two stabilizers. An economic process is also preferably characterized, in particular at a continuous process, by long-term runnability, e.g. few to no disruptions due to occurring corrosion at the apparatus for conducting of the process or due to undesired particle formation causing for example clogging at the apparatus or quality fluctuations of the process product. Furthermore, the release of smelly volatiles during the process, especially in case of heating, is not desirable. Finally, the obtained product of the process should not be affected too much by the stabilization in its visual appearance. This comprises an initial colouration after the process, which can be caused by general discolouration or specifically by precipitation of elemental copper metal traces, or a postcolouration of the polyamide due to absorption of water.

It is thus an object of the present invention to provide a solution, which addresses at least some of the aforementioned requirements.

The object has been achieved by a method for manufacturing of a stabilized polyamide-containing composition, which contains at least 20% by weight of polyamide, which comprises the steps of
incorporating of a metal organic framework,
   which is a copper-based metal organic framework comprising
   metal ions, which are copper(II)-ions, and
   a C6-C₂₄ aromatic hydrocarbon, which is substituted with at least two carboxylate groups,
   wherein two of the at least two carboxylate groups are forming coordinative bonds to the metal ions,
into a polyamide-containing composition, which contains at least 20% by weight of polyamide, to obtain a mixture for molding, which contains at least 20% by weight of polyamide; and
heating of the obtained mixture for molding comprising the polyamide-containing composition and the metal organic framework to a temperature between 170° C. and 380° C.

A metal organic framework, which is a copper-based metal organic framework, possesses a three-dimensional, well-defined structure, which differentiates itself from an amorphous state of a salt of the same elemental formula. Due to said three-dimensional, well-defined structure, a copper-based metal organic framework is crystal-line. This crystallinity leads for example to characteristic lines in an X-ray diffraction diagram.

Typically, a copper-based metal organic framework is synthetically obtained, if the synthesis reaction is thermodynamically controlled to allow that equilibrium reactions can take place during and for the build-up of the three-dimensional, well-defined structure based on the coordinative bonds. Accordingly, a simple precipitation reaction between an alkaline salt of a dicarboxylate derivative and a copper(II) salt of a strong acid is insufficient to obtain a copper-based metal organic framework. Though in the latter case, polymeric chains with the sequence copper(II)-ion⇄carboxylate group—organic core—carboxylate group⇄copper(II)-ion might partly be formed, said polymeric chains do not arrange consistently to a three-dimensional, well-defined structure. Instead, an amorphous state, which comprises clustered and fragmented arrangements, results.

A copper-based metal organic framework, which comprises metal ions, which are copper(II)-ions, comprises a C₆-C₂₄ aromatic hydrocarbon, because on one side, an aliphatic hydrocarbon results typically in a metal organic framework, which is less stable under exposure to heat, and on the other side, because a hetero-atom like nitrogen or sulfur in an arene often induces discolouration due to coloured degradation products formed once the arene is exposed for a prolonged time to light.

A C₆-C₂₄ aromatic hydrocarbon, which is substituted with at least two carboxylate groups, is for example benzene-1,2-dicarboxylate (ortho-phthalate), benzene-1,3-dicarboxylate (iso-phthalate), benzene-1,4-dicarboxylate (terephthalate), benzene-1,3,5-tricarboxylate, benzene-1,2,4-tricarboxylate, benzene-1,2,4,5-tetracarboxylate, napthalene-1,3-dicarboxylate, napthalene-1,4-dicarboxylate, naphthalene-1,5-dicarboxylate, napthalene-2,6-dicarboxylate, naphthalene-1,3,5,7-tetracarboxylate, naphthalene-2,3,6,7-tetracarboxylate, biphenyl-2,2′-dicarboxylate, biphenyl-3,3′-dicarboxylate, biphenyl-4,4′-dicarboxylate, biphenyl-3,4′-dicarboxylate, biphenyl-3,4,3′-tricarboxylate, biphenyl-3,5,3′-tricarboxylate, biphenyl-3,5,4′-tricarboxylate, biphenyl-3,5,3′,5′-tetracarboxylate, anthracene-1,2-dicarboxylate, anthracene-1,3-dicarboxylate, anthracene-2,3-dicarboxylate, anthracene-1,4-dicarboxylate, anthrancene-1,5-dicarboxylate, anthracene-1,8-dicarboxylate, anthracene-2,6-dicarboxylate, anthracene-2,3,6,7-tetracarboxylate, 4-[4-(4-carboxylatophenyl)phenyl]benzoate, 4-[3-(4-carboxylatophenyl)phenyl]benzoate, 4-[4-(3-carboxylatophenyl)phenyl]benzoate, 5-[3-(4-carboxylatophenyl)phenyl]benzene-1,3-dicarboxylate, 5-[3-(4-carboxylatophenyl)-phenyl]benzene-1,2-dicarboxylate, 4-[3,5-bis(4-carboxylatophenyl)phenyl]benzoate, 4-[3-(4-carboxylatophenyl)-5-(3-carboxylatophenyl)phenyl]benzoate, 5-[3-(3-carboxylatophenyl)-5-(4-carboxylatophenyl)phenyl]benzene-1,3-dicarboxylate, perylene-3,4,9-tricarboxylate or perylene-3,4,9,10-tetracarboxylate.

A fused aromatic hydrocarbon ring systems show UV absorption spectra shifted towards long wavelength absorption, which can cause undesirable absorption or fluorescence derogating the visual appearance of the stabilized polyamide. Therefore, a C₆-C₂₄ aromatic hydrocarbon, which is a benzene, a diphenyl, a triphenyl or 1,3,5-triphenylbenzene, is preferred. This is of particular relevance for a stabilized polyamide-containing composition, which is free of a colorant or another ingredient, which absorb or fluoresce in the visible area between 380 to 780 nm wavelength. It can also be of particular relevance, if the stabilized polyamide-containing composition comprises a colorant, which generates a very brilliant shade.

The copper-based metal organic framework is built on the principle that a copper(II) ion coordinatively bonds to two carboxylate groups, which are not located on the same aromatic hydrocarbon.

Preferred is a copper-based metal organic framework, wherein each of the metal ions, which are copper(II) ions, bonds coordinatively to two carboxylate groups, which are not located on the same aromatic hydrocarbon.

Preferred is a method for manufacturing of a stabilized polyamide-containing composition, which contains at least 20% by weight of polyamide, which comprises the steps of
incorporating of a metal organic framework,
   which is a crystalline copper-based metal organic framework comprising
   metal ions, which are copper(II)-ions, and
   a C6-C₂₄ aromatic hydrocarbon, which is substituted with at least two carboxylate groups,
   wherein two of the at least two carboxylate groups are forming coordinative bonds to the metal ions, and
   wherein each of the metal ions bonds coordinatively to two carboxylate groups, which are not located on the same aromatic hydrocarbon,
into a polyamide-containing composition, which contains at least 20% by weight of polyamide, to obtain a mixture for molding, which contains at least 20% by weight of polyamide; and
heating of the obtained mixture for molding comprising the polyamide-containing composition and the metal organic framework to a temperature between 170° C. and 380° C.

An aromatic hydrocarbon, which allows geometrically that one copper(II) ion bonds to two of its carboxylate groups, results typically in a less heat-stable copper-based metal organic framework. Hence, a C₆-C₂₄ aromatic hydrocarbon, which is substituted with at least two carboxylate groups, is preferred, wherein two of the at least two carboxylate groups are separated by at least 3 carbon atoms. More preferred is a C₆-C₂₄ aromatic hydrocarbon, which is substituted with at least two carboxylate groups, wherein two of the at least two carboxylate groups are separated by at least 3 carbon atoms and wherein said two of the at least two carboxylate groups are not able to form in their free acid form under release of water an intramolecular 6- or 7-membered cyclic anhydride.

In particular preferred is a C₆-C₂₄ aromatic hydrocarbon, which is substituted with at least two carboxylate groups, wherein two of the at least two carboxylate groups are not able to form in their free acid form under release of water an intramolecular 5-, 6- or 7-membered cyclic anhydride. Very preferred is a C₆-C₂₄ aromatic hydrocarbon, which is substituted with at least two carboxylate groups, wherein all of the at least two carboxylate groups are separated by at least 3 carbon atoms. In particular very preferred is a C₆-C₂₄ aromatic hydrocarbon, which is substituted with at least two carboxylate groups, wherein all of the at least two carboxylate groups are not able to form in their free acid form under release of water an intramolecular 5-, 6- or 7-membered cyclic anhydride.

Preferred is a metal organic framework, which is a copper-based metal organic framework comprising metals ions, which are copper(II)-ions, and a C₆-C₂₄ aromatic hydro-carbon, which is substituted with at least two carboxylate groups, wherein two of the at least two carboxylate groups are separated by at least 3 carbon atoms of the C₆-C₂₄ aromatic hydrocarbon, and with the proviso that said two of the at least two carboxylate groups are forming coordinative bonds to different ones of the metal ions.

Preferred is a metal organic framework, which is a copper-based metal organic framework comprising metals ions, which are copper(II)-ions, and a C₆-C₂₄ aromatic hydro-carbon, which is substituted with at least two carboxylate groups, wherein said two of the at least two carboxylate groups are separated by at least 3 carbon atoms of the C₆-C₂₄ aromatic hydrocarbon, and wherein said two of the at least two carboxylate groups are not able to form in their free acid form under release of water an intramolecular 6- or 7-membered cyclic anhydride, and with the proviso that said two of the at least two carboxylate groups are forming coordinative bonds to different ones of the metal ions.

Preferred is a metal organic framework, which is a copper-based metal organic framework comprising metals ions, which are copper(II)-ions, and a C₆-C₂₄ aromatic hydro-carbon, which is substituted with at least two carboxylate groups, wherein said two of the at least two carboxylate groups are separated by at least 3 carbon atoms of the C₆-C₂₄ aromatic hydrocarbon, and wherein all of the at least two carboxylate groups are not able to form in their free acid form under release of water an intramolecular 6- or 7-membered cyclic anhydride.

Preferred is a metal organic framework, which is a copper-based metal organic framework comprising metals ions, which are copper(II)-ions, and a C₆-C₂₄ aromatic hydro-carbon, which is substituted with at least two carboxylate groups, wherein said two of the at least two carboxylate groups are separated by at least 3 carbon atoms of the C₆-C₂₄ aromatic hydrocarbon, and wherein all of the at least two carboxylate groups are not able to form in their free acid form under release of water an intramolecular 6- or 7-membered cyclic anhydride, and with the proviso that all of the at least two carboxylate groups are forming coordinative bonds to different ones of the metal ions.

Preferred is a C₆-C₂₄ aromatic hydrocarbon, which is substituted with two carboxylate groups and is isophthalate or terephthalate, or a C₆-C₂₄ aromatic hydrocarbon, which is substituted with three carboxylate groups and is benzene-1,3,5-tricarboxylate.

A copper-based metal organic framework is also more heat-stable, if the aromatic hydrocarbon possess more than two carboxylate groups, because than even an interruption of one of the coordinative bonds of the copper(II)-ion to a carboxylate group does not result in an interruption due to the at least two other carboxylate groups of the aromatic hydrocarbon, which are coordinatively bonded to different ones of the metal ions. Therefore, a C₆-C₂₄ aromatic hydrocarbon, which is substituted with at least three carboxylate groups, is preferred. More preferred is a C₆-C₂₄ aromatic hydrocarbon, which is substituted with at least three carboxylate groups, wherein all of the carboxylate groups are separated by at least 3 carbon atoms. Very preferred is a C₆-C₂₄ aromatic hydrocarbon, which is substituted with at least three carboxylate groups, wherein all of the at least three carboxylate groups are not able to from in their free acid form under release of water an intramolecular 5-, 6- or 7-membered cyclic anhydride. In particular preferred is a C₆-C₂₄ aromatic hydrocarbon, which is substituted with at least three carboxylate groups, wherein all of the at least three carboxylate groups are not able to from in their free acid form under release of water an intramolecular 5-, 6- or 7-membered cyclic anhydride, and with the proviso that all of the at least three carboxylate groups are forming coordinative bonds to different ones of the metal ions.

Specifically preferred is a C₆-C₂₄ aromatic hydrocarbon, which is substituted with three carboxylate groups and is 1,3,5-benzene-tricarboxylate. This specifically preferred metal organic framework is the compound (101) obtained in example 1. It is commercially available as Basolite C300 (RTM BASF).

A metal organic framework, which is a copper-based metal organic framework, usually comprises pores, especially micro- and/or mesopores. Micropores are defined as those having a diameter of 2 nm or less, and mesopores are defined by a diameter in the range from 2 to 50 nm, in each case corresponding to the definition as specified by Pure & Applied Chem. 57 (1985), 603-619, more particularly on page 606. The presence of micro- and/or mesopores can be tested with the aid of sorption measurements, these measurements determining the absorption capacity of the metal organic framework for nitrogen at 77 Kelvin to DIN 66131 and/or DIN 66134.

The specific surface area—calculated by the Langmuir model to DIN 66135 (DIN 66131, 66134)—for a metal organic framework in powder form is more than 5 m²/g, more preferably more than 10 m²/g, more preferably more than 50 m²/g, even more preferably more than 500 m²/g, even more preferably more than 1000 m²/g and especially preferably more than 1500 m²/g.

The metal-organic framework material may also have no pores or have such small pores that a determination of the specific surface areas with nitrogen is impossible. Preferably, pores are present.

Preferred is a method for manufacturing of a stabilized polyamide-containing composition, wherein the copper-based metal organic framework has a specific surface area, determined in accordance with DIN 66135, of more than 5 m²/g.

The polyamide-containing composition, the mixture for molding and the stabilized polyamide-containing composition contain at least 20% by weight of polyamide. Preferred is a weight content of at least 40%, more preferred of at least 50%, very preferred of at least 70% and particularly preferred of at least 85%.

Preferred is a method for manufacturing of a stabilized polyamide-containing composition, wherein the polyamide-containing composition contains at least 50% by weight of polyamide.

Preferred is a method for manufacturing of a stabilized polyamide-containing composition, wherein the mixture for molding contains at least 50% by weight of polyamide.

Preferred is a method for manufacturing of a stabilized polyamide-containing composition, wherein the stabilized polyamide-containing composition contains at least 50% by weight of polyamide.

Preferred is a method for manufacturing of a stabilized polyamide-containing composition, wherein the polyamide-containing composition, the mixture for molding and the stabilized polyamide-containing composition contain at least 50% by weight of polyamide.

The polyamide-containing composition, prior to the incorporation of the metal organic framework, can be in a physical form of a powder, of pellets or of granules.

Incorporation of the metal organic framework into the polyamide-containing composition can be conducted in a mixing apparatus. The mixing apparatus can be open, for example a vessel with a stirrer, or closed, for example a Banbury mixer, a kneader or an extruder. The mixing apparatus can comprise roll mills, mixing instruments or grinding instruments. As a result of the step of incorporating, a mixture for molding is obtained. In the mixture for molding, the metal organic framework is finely distributed in the polyamide-containing composition, but it is not yet homogenously distributed in the polyamide itself. While incorporating can involve a period of elevated temperature, the mixture for molding is characterized in that the mixture for molding has not been heated to a temperature above 160° C. Preferably, 80% by weight of the original metal organic framework, which is incorporated into the polyamide-containing composition, is crystalline in the obtained mixture for molding.

The obtained mixture for molding can be in a physical form of a powder, of pellets or of granules. If the mixture for molding is obtained in a different form, in particular, a comminuting step can be conducted between the incorporating and heating step. This is preferred, if the physical form of the obtained mixture for molding is not suited for the heating step.

Heating of the obtained mixture for molding, which comprises the polyamide-containing composition and the metal organic framework, to a temperature between 170° C. and 380° C. can be conducted in a mixing apparatus, which allows a transfer of thermal energy into the mixture for molding. The transfer of thermal energy can be performed by heating elements, for example a part of the mixing apparatus, which is in contact with the mixture for molding, is set to an increased temperature. Furthermore, an additional transfer of thermal energy into the mixture for molding can be achieved by a mechanical agitation of the mixture for molding under high shear, which leads to a transformation of externally applied mechanical energy into thermal energy of the mixture for molding.

During the heating step, the metal organic framework is homogenously distributed in the polyamide. After such a mass-additivation of the polyamide with the metal organic framework, the stabilized polyamide-containing composition is obtained.

The temperature for heating of the mixture for molding is between 170° C. and 380° C., preferably between 180° C. to 350° C., in particular between 200° C. to 330° C. and especially between 240° C. to 320° C.

Preferred is a method for manufacturing of a stabilized polyamide-containing composition, wherein the temperature at the heating is between 180° C. to 350° C.

A preferred mixing apparatus for incorporating or heating is an extruder or a cokneader. Examples for an extruder are a single-screw extruder, a corotating twin-screw extruder, a counterrotating twin-screw extruder, a planetary transmission extruder or a ring extruder. The preferred mixing apparatus can be equipped with at least one gas removal chamber, to which vaccum can be applied.

At an extruder with a screw, the screw length is 1 to 60 screw diameters, preferably 35 to 48 screw diameters. A rotation speed of the screw is preferably 10 to 600 revolutions per minute (rpm), most preferably 25 to 300 rpm. The maximum throughput depends on the screw diameter, the rotation speed and the driving force.

At an extruder, the use of a metal organic framework in a polyamide-containing composition can suppress metal corrosion of the extruder screw or the cylinder parts of the extruder during extruding.

Preferred is a method for manufacturing a stabilized polyamide-containing composition, wherein the incorporating is conducted in an extruder.

Preferred is a method for manufacturing a stabilized polyamide-containing composition, wherein the heating is conducted in an extruder.

Preferred is a method for manufacturing a stabilized polyamide-containing composition, wherein the incorporating and the heating is conducted in the same mixing apparatus, which is an extruder or a cokneader, in particular an extruder.

The incorporating step of the metal organic framework can take place directly prior to the heating without an isolation of the mixture for molding. This is more economic since an isolation of the mixture for molding is spared. An example is the incorporating of the metal organic framework into the polyamide-containing composition at an intake zone of a heated extruder, where mixing is performed and a heating element with increased temperature is also present, which warms the polyamide-containing composition.

Preferred is a method for manufacturing of a stabilized polyamide-containing composition, wherein the mixture for molding is not isolated between the step of incorporation and the step of heating.

Furthermore, the incorporating step and the heating step can take place at the same time without an isolation of a mixture for molding. This is economically advantageous in case that the same uniformly homogenous distribution of the metal organic framework in the polyamide is obtained at the final stabilized polyamide-containing composition than if a mixture for molding is formed separately prior to the heating step. An example is the incorporating of the metal organic framework in an already warm polyamide-containing composition. This can occur when the metal organic framework is added via a side-feeding channel in an extruder, wherein the polyamide-containing composition is processed.

Preferred is a method for manufacturing of a stabilized polyamide-containing composition, wherein the step of incorporation and the step of heating take place at the same time. Preferably, the step of incorporation and the step of heating take place at the same time and a mixture for molding is not isolated.

The method for manufacturing a stabilized polyamide-containing composition can comprise the further step of shaping the stabilized polyamide-containing composition directly after the heating and prior to cooling to room temperature to obtain a shaped product. Examples for specific shaping methods are calendering, compression molding, extruding, casting or injection-molding.

Two types of shaped articles can be distinguished: a shaped final article, wherein the stabilized polyamide-containing composition is in a shape as finally desired, or a shaped intermediate composite, wherein the stabilized polyamide-containing composition is in a shape, which is beneficial for a further processing.

A physical form of the shaped intermediate composite can be a pellet, a granulate or—after grinding—a powder.

It is possible that the method for manufacturing a stabilized polyamide-containing composition comprises a further heating step at a temperature between 170° C. and 380° C., and a further shaping step, wherein the further shaping step follows directly after the further heating step without cooling to room temperature between said steps.

For example, the mixture for molding is heated and shaped to obtain the shaped intermediate composite in the physical form of pellets or granules. These pellets or granulates are heated again and shaped again to obtain the shaped final article. Typically, the further heating step takes place at a higher temperature than the heating step. Typically, the further shaping step takes place under higher mechanical forces, for example pressure, than the shaping step. Examples for a further heating and a further shaping are calendering, compression molding, extruding, casting or injection molding.

Preferred is a further heating step and a further shaping step, which is extruding, in particular melt fiber spinning.

Preferred is a method for manufacturing of a stabilized polyamide-containing composition, which is a shaped article and which contains at least 20% by weight of polyamide, which comprises the steps of
incorporating of a metal organic framework,
   which is a copper-based metal organic framework comprising
   metal ions, which are copper(II)-ions, and
   a C⁶-C₂₄ aromatic hydrocarbon, which is substituted with at least two carboxylate groups,
   wherein two of the at least two carboxylate groups are forming coordinative bonds to the metal ions,
into a polyamide-containing composition, which contains at least 20% by weight of polyamide, to obtain a mixture for molding, which contains at least 20% by weight of polyamide;
heating of the obtained mixture for molding comprising the polyamide-containing composition and the metal organic framework to a temperature between 170° C. and 380° C.; and
shaping the stabilized polyamide-containing composition directly after the heating and prior to cooling to room temperature to obtain a shaped article.

Preferred is a method for manufacturing a stabilized polyamide-containing composition, which is a shaped article, wherein the heating is conducted in an extruder and the shaping is conducted after an orifice of the extruder.

Preferred is a method for manufacturing of a stabilized polyamide-containing composition, which is a shaped final article and which contains at least 20% by weight of polyamide, which comprises the steps of
incorporating of a metal organic framework,
   which is a copper-based metal organic framework comprising
   metal ions, which are copper(II)-ions, and
   a C₆-C₂₄ aromatic hydrocarbon, which is substituted with at least two carboxylate groups,
   wherein two of the at least two carboxylate groups are forming coordinative bonds to the metal ions,
into a polyamide-containing composition, which contains at least 20% by weight of polyamide, to obtain a mixture for molding, which contains at least 20% by weight of polyamide;
heating of the obtained mixture for molding comprising the polyamide-containing composition and the metal organic framework to a temperature between 170° C. and 380° C.; and
shaping the stabilized polyamide-containing composition directly after the heating and prior to cooling to room temperature to obtain a shaped intermediate composite;
further heating of the obtained shaped intermediate composite to a further temperature between 170° C. and 380° C.; and
further shaping directly after the heating and prior to cooling to room temperature to obtain a shaped final article.

Preferred is a method for manufacturing a stabilized polyamide-containing composition, which is a shaped final article, wherein the further heating and the further shaping are melt fiber spinning.

In the method for manufacturing of a stabilized polyamide-containing composition, the metal organic framework can be incorporated in an amount between 0.003% and 3% based on the weight of the polyamide contained in the polyamide-containing composition. Preferred is the incorporation of the metal organic framework in an amount between 0.003% and 1.2%, more preferred between 0.006% and 0.6%, very preferred between 0.012% and 0.45%.

A copper content is defined as the overall amount by weight of copper atoms. For stabilization of the polyamide in the stabilized polyamide-containing composition, a copper content is desired to be between 0.001% and 1% by weight of the polyamide, which is contained in the stabilized polyamide-containing composition. Preferably, the copper content is between 0.001% and 0.4%, more preferred between 0.002% and 0.2%, very preferred between 0.004% and 0.15%.

Preferred is a method for manufacturing a stabilized polyamide-containing composition, wherein the metal organic framework is incorporated in an amount between 0.003% and 3% based on the weight of the polyamide contained in the polyamide-containing composition.

Preferred is a method for manufacturing a stabilized polyamide-containing composition, wherein the metal organic framework is incorporated in such an amount that the copper content in the stabilized polyamide-containing composition is between 0.001% and 1% by weight of the polyamide.

Preferred is a method for manufacturing a stabilized polyamide-containing composition, wherein the metal organic framework is incorporated in an amount between 0.003% and 3% based on the weight of the polyamide contained in the polyamide-containing composition and wherein the incorporated amount results in a copper content in the stabilized polyamide-containing composition between 0.001% and 1% by weight of the polyamide.

In the polyamide-containing composition or in the stabilized polyamide-containing composition, a further component can be present. The further component can already be present in the polyamide-containing composition, which contains at least 20% by weight of polyamide, or the further component can be added during the method for manufacturing of a stabilized polyamide-containing composition, in particular during the incorporation step. A further component can be another stabilizer, another polymer, a colorant, a filler, a flame retardant, a nucleating agent or a processing aid. Another stabilizer is a stabilizer, which is different to the metal organic framework, which is a copper-based metal organic framework comprising metal ions, which are copper(II)-ions, and a C₆-C₂₄ aromatic hydrocarbon, which is substituted with at least two carboxylate groups, wherein two of the at least two carboxylate groups are forming coordinative bonds to the metal ions. Another polymer is a polymer, which is different to polyamide.

Preferred is a method for manufacturing of a stabilized polyamide-containing composition, wherein the polyamide-containing composition contains a further component.

Preferred is a method for manufacturing of a stabilized polyamide-containing composition, which comprises the further step of adding a further component.

Preferred is a method for manufacturing of a stabilized polyamide-containing composition, wherein a further component is incorporated into the polyamide-containing composition during the incorporation step, and wherein the further component is another stabilizer, another polymer, a colorant, a filler, a flame retardant, a nucleating agent or a processing aid.

Another stabilizer is for example a stabilizer out of the 7 groups listed below or a copper stabilization promoter.

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1-yl)phenol, 2,4-dimethyl-6-(1′-methyltridec-1′-yl)phenol, 2,4-dimethyl-6-(1′-methyl-1′-tetradecyl-methyl)-phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecyl-thiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate.

1.4. Tocopherols, for example a-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylene-bis(6-nonyl-4-methylphenol), 2,2′-methylenebis(4,6-di-tert-butylphenol), 2,2′-ethylidene-bis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3,3′-tert-butyl-4′-hydroxyphenyl)-butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane.

1.7. O-, N- and S-benzyl compounds, for example 3,5,3′,5′-tetra-tert-butyl-4,4′-di-hydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or poly-hydric alcohols, for example with methanol, ethanol, n-octanol, i-octanol, octadecanol, a mixture of linear and branched C₁₃-C₁₅-alkanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxylethyl)isocyanurate, N,N′-bis-(hydroxylethyl)oxamide, 3-thiaundecanol, 3-thiapentadecanol, trimethylhexanediol, trime-thylolpropane, 4-hydroxymethyl-1-phospha-2,6,7-trioxabicyclo[2.2.2]octane.

1.14. Esters of β(5-tert-butyl-4-hydroxy-3-methylphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of β(3,5-dicyclohexyl-4-hydroxyphenyl)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]-octane.

1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid, for example N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]-propionyloxy)ethyl]oxamide (Naugard XL-1(RTM), supplied by Uniroyal).

1.18 Aminic antioxidants, for example N,N′-di-isopropyl-p-phenylenediamine, N,N′-disec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tertbutyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene.

2. UV Absorbers and Light Stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tertamyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

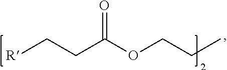

where R′=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-62 ,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate, N-(β-carbomethoxy-β-cyanovinyl)-2-methylindoline and neopentyl tetra(α-cyano-β,β-diphenylacrylate).

2.5. Nickel compounds, for example nickel complexes of 2,2′-thiobis[4-(1,1,3,3-tetra-methylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidy)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, N1,N3-bis(2,2,6,6-tetramethyl-4-piperidyl)benzene-1,3-dicarboxamide, 3-n-octyl-7,7,9,9-tetramethyl-1,3,8-triazaspiro[4.5]decane-2,4-dione, bis(1-octyloxy-2,2,6,6-tetramethylpiperid-4-yl)sebacate, bis(1-octyloxy-2 ,2 ,6,6-tetramethylpiperid-4-yl)succinate, bis-[2,2,6,6-tetramethyl-1-(undecyloxy)-piperidin-4-yl]carbonate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropyl-amino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268 64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)-ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxy-piperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, a mixture of oligomeric compounds which are the formal condensation products of N,N′-bis-(2,2,6,6-tetramethyl-1-propoxy-piperidin-4-yl)-hexane-1,6-diamine and 2,4-dichloro-6-{n-butyl-(2,2,6,6-tetramethyl-1-propoxy-piperidin-4-yl)-amino}-[1,3,5]triazine end-capped with 2-chloro-4,6-bis-(di-n-butylamino)-[1,3,5]triazine, a mixture of oligomeric compounds which are the formal condensation products of N,N′-bis-(2,2,6,6-tetramethyl-piperidin-4-yl)-hexane-1,6-diamine and 2,4-dichloro-6-{n-butyl-(2,2,6,6-tetramethyl-piperidin-4-yl)-amino}-[1,3,5]triazine end-capped with 2-chloro-4,6-bis-(di-n-butylamino)-[1,3,5]triazine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (RTM Clariant; CAS Reg. No. 106917-31-1], 5-(2-ethylhexanoyl)-oxymethyl-3,3,5-trimethyl-2-morpholinone, the reaction product of 2,4-bis-[(1-cyclo-hexyloxy-2,2,6,6-piperidine-4-yl)butylamino]-6-chloro-s-triazine with N,N′-bis-(3-amino-propyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyhoxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]--4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[(2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]-phenyl}-4,6-bis [symbol] (2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tertbutylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl-(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane. Preferred phosphites are tris(2,4-di-tert-butylphenyl)phosphite (Irgafos 168, RTM BASF) or bis(2,4-di-tertbutyl-6-methylphenyl)ethyl posphite (Irgafos 38, RTM BASF).

5. Hydroxylamines and amine N-oxides, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine or N,N-bis-(hydrogenated rape-oil alkyl)-N-methyl-amine N-oxide.

6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Benzofuranones and indolinones, for example 3-[4-(2-acetoxyethoxy)phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxy-phenyl)-5,7-di-tert-butylbenzofuran-2-one, 3-(3,4-dimethylphenyl)-5,7-di-tert-butyl-benzofuran-2-one, 3-(2,3-dimethylphenyl)-5,7-di-tert-butylbenzofuran-2-one and 3-(2-acetoxy-4-(1,1,3,3-tetramethyl-butyl)-phenyl)-5-(1,1,3,3-tetramethyl-butyl)-benzofuran-2-one.

The overall content of a further component, which is another stabilizer or a copper stabilization promoter, is preferably from 0.05% to 7%, in particular from 0.1% to 3%, very especially from 0.15% to 1.2%, based on the weight of the stabilized polyamide-containing composition.

A copper stabilization promoter can be a halide salt, wherein the halide is chloride, bromide or iodide. Salt halide is understood herein as a salt, wherein the halogen, which is a chlorine, bromine or iodine, is in the anionic form of chloride, bromine or iodide. Preferred metal ions of these halide salts are elements of the main groups IA and IIA of the periodic table of the elements, in particular sodium or potassium. Preferred halide salts are sodium chloride, sodium bromide, sodium iodide, potassium chloride, potassium bromide, potassium iodide, magnesium chloride or calcium chloride. Very preferred halide salts are potassium bromide and potassium iodide.

The copper stabilization promoter is commonly employed in a ratio at the stabilized polyamide-containing composition, wherein the ratio of a halogen weight content, wherein the halogen is in form of a salt halide, to the overall copper weight content is above 1. The overall copper weight content is the summary of all copper atoms contained irrespectively of their oxidation number. An example is the presence of two weight parts of salt halide in relation to 1 weight part of copper. The ratio is preferably from 1.1 to 20, in particular from 1.1 to 10 and very particular from 2 to 4.

Another polymer is for example a polymer out of the 24 groups listed below.

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the periodic table of elements. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the periodic table of elements. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene opolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene (EPDM); and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof.

A special copolymer of two monoolefins is a pipe grade polypropylene random copolymer, which is obtainable from the polymerization of more than 90% by weight of propylene and of less than 10% by weight, typically between 2 and 6% by weight, of ethylene.

4. Hydrocarbon resins (for example C₅-C₉) including hydrogenated modifications there-of (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(a-methylstyrene).

6. Aromatic homopolymers and copolymers derived from vinyl aromatic monomers including styrene, α-methylstyrene, all isomers of vinyl toluene, especially p-vinyl-toluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile on polybutadiene (ABS); styrene and methacrylonitrile) on polybutadiene (MBS); styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, for exaxple polyethylene glycol, polypropylene glycol, polytetramethylene glycol or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulphides, and mixtures of polyphenylene oxides with styrene polymers.

15. Polyurethanes, for example polyurethanes synthesized from a polyol and an aliphatic or aromatic polyisocyanate such as polyurethanes derived from hydroxyl-terminated polyethers, polyesters or polybutadienes on the one hand and aliphatic or aromatic polyisocyanates on the other, as well as precursors thereof.

Hydroxyl-terminated polyethers are known and are prepared, for example, by polymerizing epoxides such as ethylene oxide, propylene oxide, butylene oxide, tetrahydrofuran, styrene oxide or epichlorohydrin with themselves, for example in the presence of BF_{3,} or by addition reaction of these epoxides, alone or as a mixture or in succession, with starting components containing reactive hydrogen atoms, such as water, alcohols, ammonia or amines, for example ethylene glycol, propylene 1,3- and 1,2-glycol, trimethylolpropane, 4,4′-dihydroxydiphenylpropane, aniline, ethanolamine or ethylenediamine. Sucrose polyethers are also suitable in accordance with the invention. In many cases preference is given to those polyethers which predominantly (up to 90% by weight, based on all the OH groups present in the polyether) contain primary OH groups. Furthermore, polyethers modified by vinyl polymers, as are formed, for example, by polymerizing styrene and acrylonitrile in the presence of polyethers, are suitable, as are polybutadienes containing OH groups.

In particular, a polyol compound has a molecular weight of 400-10000, especially 800 to 10000, and is a polyhydroxy compound, especially containing from 2 to 8 hydroxyl groups, especially from 2 to 4.

Suitable polyisocyanates are aliphatic or aromatic, for example ethylene diisocyanate, 1,4-tetramethylene diisocyanate, 1,6-hexamethylene diisocyanate, 1,12-dodecane diisocyanate, cyclobutane 1,3-diisocyanate, cyclohexane 1,3- and -1,4-diisocyanate and also any desired mixtures of these isomers, 1-isocyanato-3,3,5-trimethyl-5-isocyanatomethylcyclohexane, 2,4- and 2,6-hexahydrotolylene diisocyanate and also any desired mixtures of these isomers, hexahydro-1,3- and/or -1,4-phenylene diisocyanate, perhydro-2,4′- and/or -4,4′-diphenylmethanediisocyanate, 1,3- and 1,4-phenylene diisocyanate, 2,4- and 2,6-tolylene diisocyanate, and also any desired mixtures of these isomers, diphenylmethane 2,4′- and/or -4,4′-diisocyanate, naphthylene 1,5-diisocyanate, triphenylmethane 4,4′,4″-triisocyanate, polyphenyl-polymethylene polyisocyanates as are obtained by aniline-formaldehyde condensation followed by phosgenization, m- and p-isocyanatophenylsulfonyl isocyanates, perchlorinated aryl polyisocyanates, polyisocyanates containing carbodiimide groups, polyisocyanates containing allophanate groups, polyisocyanates containing isocyanurate groups, polyisocyanates containing urethane groups, polyisocyanates containing acylated urea groups, polyisocyanates containing biuret groups, polyisocyanates containing ester groups, reaction products of the abovementioned isocyanates with acetals, and polyisocyanates containing polymeric fatty acid radicals.

It is also possible to employ the isocyanate group-containing distillation residues, as they are or dissolved in one or more of the abovementioned polyisocyanates, which are obtained in the course of the industrial preparation of isocyanates. It is additionally possible to use any desired mixtures of the abovementioned polyisocyanates.

Preferred are 2,4- or 2,6-tolylene diisocyanate and any desired mixtures of these isomers (“TDI”), polyphenyl-polymethylene-polyisocyanates as prepared by aniline-formal-dehyde condensation followed by phosgenization (“crude MDI”) or polyisocyanates containing carbodiimide, urethane, allophanate, isocyanurate, urea or biuret groups (“modified polyisocyanates”).

The polyurethanes can be homogeneous polyurethanes or cellular.

16. Polyureas, polyimides, polyetherimides, polyesterimides, polyhydantoins and polybenzimidazoles.

17. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutylenesuccinate/terephtalate, polybutyleneadipate/terephthalate, polytetramethylenead-ipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lacide and any mixtures thereof.

18. Polycarbonates and polyester carbonates.

19. Polyketones.

20. Polysulfones, polyether sulfones and polyether ketones.

21. Crosslinked polymers derived from aldehydes on the one hand and phenols, ureas and melamines on the other hand, such as phenol/formaldehyde resins, urea/formaldehyde resins and melamine/formaldehyde resins.

22. Unsaturated polyester resins derived from copolyesters of saturated and unsaturated dicarboxylic acids with polyhydric alcohols and vinyl compounds as crosslinking agents, and also halogen-containing modifications thereof of low flammability.

23. Crosslinkable acrylic resins derived from substituted acrylates, for example epoxy acrylates, urethane acrylates or polyester acrylates.

24. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

Especially preferred as another polymer are polymers, which are high density polyethylene, polypropylene, terpolymers of ethylene with propylene and a diene such as hexadiene, dicyclopentadiene or ethylidene-norbornene, styrene and acrylonitrile on polybutadiene (ABS), polyethylene glycol, polypropylene glycol, polytetramethylene glycol or polyphenylene oxides.

Preferred as another polymer are polymers, which possess elastomeric properties. These are often referred to as elastomers, impact modifiers or rubbers.

In quite general terms, elastomers are copolymers, which have preferably been formed from at least two of the following monomers: ethylene, propylene, butadiene, isobutene, isoprene, chloroprene, vinyl acetate, styrene, acrylonitrile and acrylic and/or methacrylic esters having from 1 to 18 carbon atoms in the alcohol component.

Preferred types of such elastomers are those known as ethylene-propylene (EPM) and ethylene-propylene-diene (EPDM) rubbers.

EPM rubbers generally have virtually no residual double bonds, whereas EPDM rubbers may have from 1 to 20 double bonds per 100 carbon atoms.

Examples of diene monomers for EPDM rubbers include conjugated dienes, such as isoprene and butadiene, nonconjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes such as cyclopentadiene, cyclohexadienes, cyclooctadienes and dicyclopentadiene, and also alkenylnorbornenes such as 5-ethylidene-2-norbornene, 5-butylidene-2-norbornene, 2 methallyl-5-norbornene and 2-isopropenyl-5-norbornene, and tricyclodienes such as 3 methyltricyclo[5.2.1.02,6]-3,8-decadiene, or mixtures thereof. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also be grafted with reactive carboxylic acids or with derivatives of these. Examples include acrylic acid, methacrylic acid and derivatives thereof, e.g. glycidyl (meth)acrylate, and also maleic anhydride.

A further group of preferred elastomers is that of copolymers of ethylene with acrylic acid and/or methacrylic acid and/or with the esters of these acids. The rubbers may additionally comprise dicarboxylic acids such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formula Ie, IIe, IIIe or IVe

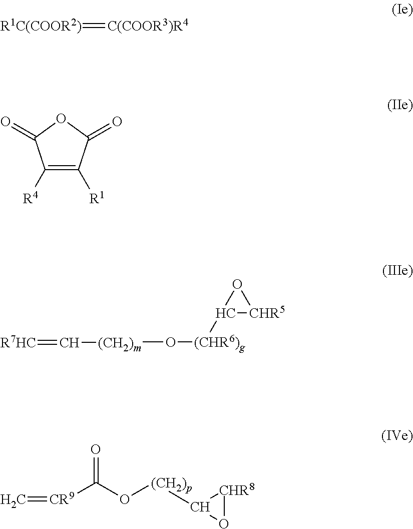

where R¹ to R⁹ are each hydrogen or alkyl groups having from 1 to 6 carbon atoms, and m is an integer from 0 to 20, g is an integer from 0 to 10 and p is an integer from 0 to 5.

The R¹ to R⁹ radicals are preferably each hydrogen, where m is 0 or 1 and g is 1. The corresponding compounds are maleic acid, fumaric acid, maleic anhydride, allyl glycidyl ether and vinyl glycidyl ether.

Preferred compounds of the formulae Ie, IIe and IVe are maleic acid, maleic anhydride and epoxy group-comprising esters of acrylic acid and/or methacrylic acid, such as glycidyl acrylate and glycidyl methacrylate, and the esters with tertiary alcohols, such as tert-butyl acrylate. Although the latter do not have any free carboxyl groups, their behavior approximates to that of the free acids and they are therefore referred to as monomers with latent carboxyl groups.

The copolymers are advantageously composed of from 50 to 98% by weight of ethylene, from 0.1 to 20% by weight of monomers comprising epoxy groups and/or methacrylic acid and/or monomers comprising acid anhydride groups, the remaining amount being (meth)acrylic esters.

Particular preference is given to copolymers composed of from 50 to 98% by weight, in particular from 55 to 95% by weight, of ethylene; from 0.1 to 40% by weight, in particular from 0.3 to 20% by weight, of glycidyl acrylate and/or glycidyl methacrylate, (meth)acrylic acid and/or maleic anhydride; and from 1 to 45% by weight, in particular from 5 to 40% by weight, of n-butyl acrylate and/or 2-ethylhexyl acrylate.

Further preferred esters of acrylic and/or methacrylic acid are the methyl, ethyl, propyl, isobutyl and tert-butyl esters.

In addition, vinyl esters and vinyl ethers may also be used as comonomers.

The ethylene copolymers described above may be prepared by processes known per se, preferably by random copolymerization under elevated pressure and elevated temperature. Appropriate processes are well known.

Preferred elastomers are also emulsion polymers, which are prepared by an emulsion polymerization. The emulsifiers and catalysts which can be used are known per se.

In principle, it is possible to use homogeneously structured elastomers or else those with a shell structure. The shell-type structure is determined by the sequence of addition of the individual monomers; the morphology of the polymers is also affected by this sequence of addition.

Monomers which may be mentioned here, merely as examples, for the preparation of the rubber fraction of the elastomers are acrylates, for example n-butyl acrylate and 2 ethylhexyl acrylate, corresponding methacrylates, butadiene and isoprene, and also mixtures thereof. These monomers may be copolymerized with further monomers, for example styrene, acrylonitrile, vinyl ethers and further acrylates or methacrylates, for example methyl methacrylate, methyl acrylate, ethyl acrylate and propyl acrylate.

The soft or rubber phase (with a glass transition temperature of below 0° C.) of the elastomers may be the core, the outer envelope or an intermediate shell (in the case of elastomers whose structure has more than two shells); elastomers having more than one shell may also have more than one shell composed of a rubber phase.

When one or more hard components (with glass transition temperatures above 20° C.) are involved, in addition to the rubber phase, in the structure of the elastomer, they are generally prepared by polymerizing, as principal monomers, styrene, acrylonitrile, methacrylonitrile, α-methylstyrene, p-methylstyrene, acrylic esters or methacrylic esters, such as methyl acrylate, ethyl acrylate or methyl methacrylate. In addition, it is also possible to use smaller proportions of further comonomers.

In some cases, it has been found to be advantageous to use emulsion polymers which have reactive groups at the surface. Examples of such groups are epoxy, carboxyl, latent carboxyl, amino and amide groups, and also functional groups which may be introduced by also using monomers of the general formula

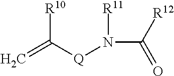

where the substituents are defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group or —OR₁₃
R¹³ is a C₁-C₈-alkyl or C₆-C₁₂-aryl group which may optionally be substituted by O- or N-containing groups,
Q is a chemical bond, a C₁-C₁₀-alkylene group or a C₆-C₁₂-arylene group, or —C(═O)—B′,
   with B′ is O—P′ or NH—P′ and P′ is C₁-C₁₀-alkylene or C₆-C₁₂-arylene.

Examples include acrylamide, methacrylamide and substituted esters of acrylic acid or methacrylic acid, such as (N-tert-butylamino)ethyl methacrylate, (N,N-dimethylamino)ethyl acrylate, (N,N-dimethylamino)methyl acrylate and (N,N diethylamino)ethyl acrylate.

The particles of the rubber phase may also be crosslinked. Examples of crosslinking monomers include 1,3-butadiene, divinylbenzene, diallyl phthalate and dihydrodicyclopentadienyl acrylate.

It is also possible to use what are known as graft-linking monomers, i.e. monomers having two or more polymerizable double bonds which react at different rates in the polymerization. Preference is given to using such compounds in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. When a further phase is then grafted onto a rubber of this type, at least some of the double bonds present in the rubber react with the graft monomers to form chemical bonds, i.e. the phase grafted on is joined at least partly to the graft base via chemical bonds.

Examples of such graft-linking monomers are monomers comprising allyl groups, in particular allyl esters of ethylenically unsaturated carboxylic acids, for example allyl acrylate, allyl methacrylate, diallyl maleate, diallyl fumarate, diallyl itaconate, or the corresponding monoallyl compounds of these dicarboxylic acids.

In general, the proportion of these crosslinking monomers in the elastomeric polymer is up to 5% by weight, preferably not more than 3% by weight, based on the elastomeric polymer.

Some preferred emulsion polymers are listed below. Mention should first be made here of graft polymers with a core and with at least one outer shell, and having the following structure:

| type | monomers for the core | monomers for the envelope |
|---|---|---|
| I | 1,3-butadiene, isoprene, n- | styrene, acrylonitrile, methyl |
| | butyl acrylate, ethylhexyl | methacrylate |
| | acrylate, or a mixture of these | |
| II | as I, but also with use of | as I |
| | crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but also with use of |
| | | monomers having reactive groups, |
| | | as described herein |
| V | styrene, acrylonitrile, methyl | first envelope composed of |
| | methacrylate, or a mixture | monomers as described under I |
| | of these | and II for the core |
| | | second envelope as described |
| | | under I or IV for the envelope |

Instead of graft polymers whose structure has more than one shell, it is also possible to use homogeneous, i.e. single-shell, elastomers composed of 1,3-butadiene, isoprene and n-butyl acrylate or their copolymers. These products too may be prepared by also using crosslinking monomers or monomers having reactive groups.

Examples of preferred emulsion polymers are n-butyl acrylate/(meth)acrylic acid copolymers, n-butyl acrylate/glycidyl acrylate or n-butyl acrylate/glycidyl methacrylate copolymers, graft polymers with an inner core composed of n-butyl acrylate or based on butadiene and with an outer envelope composed of the aforementioned copolymers, and copolymers of ethylene with comonomers which supply reactive groups.

The elastomers described may also be prepared by other conventional processes, for example by suspension polymerization.

The overall weight content of a further component, which is another polymer, is preferably from 0.1% to 25%, in particular from 0.1% to 20%, based on the weight of the stabilized polyamide-containing composition.

A colorant can be a coloured inorganic pigment, for example ultramarine blue, iron oxide or carbon black, or an organic dye, for example from the phthalocyanine class, the quinacridone class, the perylene class or the 1,4-diketopyrrolo-[3,4c]-pyrrole class. An organic dye can be an organic pigment or a polymer soluble dye. A polymer soluble dye can be a metal complex dye, for example Solvent Yellow 21 or Solvent Red 225, or a non-metal complex dye, for example Solvent Orange 60. In case a colorant is present, the addition of titanium dioxide or zinc sulfide is possible.

The overall weight content of a further component, which is a colorant, is preferably from 0.01% to 5%, in particular from 0.01% to 3%, based on the weight of the stabilized polyamide-containing composition.

A filler can act as reinforcing agent, which improves the mechanical properties of the stabilized polyamide-containing composition. Typically, the filler does not absorb light in the visible spectra, in particular above 380 nm. The filler, which can be fibrous or particulate, includes carbon fiber, glass fiber, glass bead, amorphous silica, calcium silicate, calcium metasilicate, magnesium carbonate, calcium carbonate, kaolin, bentonite, chalk, powdered quartz, mica, barium sulfate and feldspar. The amount in the polyamide-containing composition or in the stabilized polyamide-containing composition is preferably between 0.5% to 55% by weight, in particular between 1% to 30% by weight and very particular between 1% to 20% by weight. Many fillers act as a reinforcing agent, which improves the mechanical properties of the stabilized polyamide-containing composition.

Preferred fibrous fillers include carbon fibers, potassium titanate fibers and glass fibers. More preferred are glass fibers in the form of E glass. The glass fibers may be used in the form of rovings or in the commercially available forms of chopped glass.

The fibrous fillers may be surface-pretreated with a silane compound for better compatibility with the polyamide.

Acicular mineral fillers are particulate fillers with a strongly developed acicular character. An example is acicular wollastonite. The mineral preferably has an L/D (length to diameter) ratio of from 8:1 to 35:1, preferably from 8:1 to 11:1. The acicular wollastonite may, if appropriate, be pretreated with a silane compound, but the pretreatment is not essential.

Beneath wollastonite, further particulate fillers are kaolin, calcined kaolin, talc or chalk. A preferred class of fillers are platelet- or needle-like nanofillers, which are based on boehmite, bentonite, montmorillonite, vermiculite, hectorite or laponite. In order to obtain a good compatibility of the platelet-like nanofillers with the polyamide, the platelet-like nanofillers are organically modified according to the prior art. The addition of platelet-like or needle-like nanofillers leads to an increase in mechanical strength.

The overall weight content of a further component, which is a filler, is preferably from 0.5% to 55%, in particular from 1% to 30%, based on the weight of the stabilized polyamide-containing composition.

A flame retardant can contain halogen or is halogen-free. Preferred is a halogen-free flame retardant.

The overall weight content of a further component, which is a flame retardant, is preferably from 0.1% to 15%, in particular from 0.3% to 10%, based on the weight of the stabilized polyamide-containing composition.

A nucleating agent for polyamide is for example alumina, sodium phenylphosphinate, silica or talc.

The overall weight content of a further component, which is a nucleating agent, is preferably from 0.001% to 3%, in particular from 0.01% to 1%, based on the weight of the stabilized polyamide-containing composition.

A processing aid is for example a plasticiser, a lubricant, a rheology additives or a flow-control agent.

The overall weight content of a further component, which is a processing agent, is preferably from 0.1% to 15%, in particular from 1% to 10%, at the stabilized polyamide-containing composition.

It is possible that more than one further component is present. These can be combinations out of another stabilizer, another polymer, a colorant, a filler, a flame retardant, a nucleating agent or a processing aid. If more than one further component is present, the preferred overall weight content for the single further components still applies.

The overall weight content of the summary of all further components at the stabilized polyamide-containing composition is below 77%, preferably below 57%, especially below 47%, in particular below 27% and very particular below 13%.

Furthermore, it is surprisingly found that in case of a metal organic framework, which is a copper-based metal organic framework comprising
metal ions, which are copper(II)-ions, and
a C₆-C₂₄ aromatic hydrocarbon, which is substituted with at least two carboxylate groups,
   wherein two of the at least two carboxylate groups are forming coordinative bonds to the metal ions, an addition of a salt halide to promote the copper stabilization is not necessary. The degree of stabilization achieved with the metal organic framework is not further or not significantly further improved by an addition of salt halide, especially if the salt halide is added in the commonly applied ratio. The commonly employed ratio would lead to a stabilized polyamide-containing composition, wherein the ratio of an overall copper weight content to a halogen weight content, wherein the halogen is in form of a salt halide, is below 1. As an example, 1 weight part of overall copper in relation to 2 weight parts of halogen weight content, wherein the halogen is in form of a salt halide, results in a ratio of an overall copper weight content to a halogen weight content, wherein the halogen is in form of a salt halide, of 0.5.

Preferred is a method for manufacturing of a stabilized polyamide-containing composition, wherein in the stabilized polyamide-containing composition, the ratio of an overall copper weight content to a halogen weight content, wherein the halogen is in form of a salt halide, is above 1, in particular above 2, very particular above 5 and most particular above 10.

Preferred is a method for manufacturing of a stabilized polyamide-containing composition, wherein the stabilized polyamide-containing composition is essentially free of halogen, which is in form of a salt halide.

Essentially free is herein understood as a halogen content, wherein the halogen is in form of a salt halide, which is below 10 ppm by weight of the stabilized polyamide-containing composition.

Two types of halogen content of a stabilized polyamide-containing composition are distinguished. The halogen content, wherein the halogen is in form of a salt halide, refers to the overall halogen, which is contained in the form of chlorides, bromines and iodides, which are present as anions. Different to that, the general halogen content is the summary of all halogen, which is chloride, bromine or iodine, by weight, which is contained in the stabilized polyamide-containing composition. It comprises especially the organically bonded halogens. These are chloro-, bromo- or iodo-substituents of organic molecules. The chlorine, bromine or iodine of each halogenated organic molecule, which is present in the stabilized polyamide-containing composition, counts. For example, many halogenated organic flame retardants contain organically bonded chloro-, bromo- or iodo-substituents. For example, polyvinylchloride or polyvinylidene chloride contain organically bonded chloro-substituents.

Preferred is a method for manufacturing of a stabilized polyamide-containing composition, wherein in the stabilized polyamide-containing composition, the ratio of an overall copper weight content to a general halogen weight content is above 1, in particular above 2, very particular above 5 and most particular above 10.

Preferred is a method for manufacturing of a stabilized polyamide-containing composition, wherein the stabilized polyamide-containing composition is essentially free of halogen.

Essentially free is herein understood as a general halogen content, which is below 10 ppm by weight of the stabilized polyamide-containing composition.

A polyamide as defined herein can have for example a molecular weight in the range from 10⁴ g/mol to 10⁸ g/mol, in particular from 10⁵ g/mol to 10⁷ g/mol and especially from 3×10⁵ g/mol to 10⁷ g/mol.

A polyamide, which transforms at elevated temperatures, in particular at the heating to a temperature between 170° C. and 380° C., from a solid into a viscous liquid state and solidifies again once cooled down, in particular to room temperature, is defined herein as a thermoplastic polyamide. A cross-linking of the polyamide in the polyamide-containing composition might also be effected or completed at the elevated temperature, in particular at the heating to a temperature between 170° C. and 380° C. Also, a further polycondensation at the polyamide can take place at the elevated temperature, in particular at the heating to a temperature between 170° C. and 380° C., for examples at so-called RIM polyamide systems. Under the application of pressure, the heated polyamide can be shaped, for example after the orifice of an extruder, and remains its shape at room temperature.

Preferred is a method for manufacturing a stabilized polyamide-containing composition, wherein the polyamide is thermoplastic.

Preferred is a method for manufacturing a stabilized polyamide-containing composition, wherein the polyamide-containing composition contains a thermoplastic polyamide.

Polyamides are for example obtainable
from polycondensation of a diamine of formula (I)

H₂N—X—NH₂ (I)
wherein
X is C₂-C₁₂ alkylene, C₅-C₁₂ cycloalkylene, C₅-C₁₀ cycloalkyl-bis-(C₁-C₃ alkyl), C₆-C₁₀ aryl-bis-(C₁-C₃ alkyl) or C₆-C₁₀ arylene;
and of a dicarboxylic acid of formula (II)

HOOC—Y—COOH (II)
wherein
X is C₂-C₁₂ alkylene, C₅-C₁₂ cycloalkylene, C₅-C₁₀ cycloalkyl-bis-(C₁-C₃ alkyl), C₆-C₁₀ aryl-bis-(C₁-C₃ alkyl) or C₆-C₁₀ arylene;
wherein the molar ratio between a diamine of formula (I) and a dicarboxylic acid of formula (II) is close to 1;
from polycondensation of an aminocarboxylic acid of formula (III),

H₂N—Z—COOH (III)
wherein
Z is C₂-C₁₂ alkylene, C₅-C₁₂ cycloalkylene, C₅-C₁₀ cycloalkyl-bis-(C₁-C₃ alkyl), C₆-C₁₀ aryl-bis-(C₁-C₃ alkyl) or C₆-C₁₀ arylene;
or
from polycondensation of a diamine of formula (I), a dicarboxylic acid of formula (II) and an aminocarboxylic acid of formula (III);
wherein the molar ratio between a diamine of formula (I) and a dicarboxylic acid of formula (II) is close to 1.

A molar ratio close to 1 as defined herein is for example in a range from 0.9 to 1.1, in particular from 0.95 to 1.05 and especially from 0.97 to 1.03.

C₂-C₁₂ alkylene is for example ethylene, 1,3-propylene, 1-methylethyl-1,2-diyl, 1,4- butylene, 1,2-butylene, 2-methylpropylene-1,3-diyl, 1,5-pentylene, 1,6-hexylene[=hexamethylene], 1,7-heptylene, 1,8-octylene, 1,9-nonylene, 1,10-decylene, 1,11-undecylene or 1,12-dodecylene.

C₅-C₁₂ cycloalkylene is for example cyclopentene-1,2-diyl, cyclopentene-1,3-diyl, cyclohexene-1,2-diyl, cyclohexene-1,3-diyl, cyclohexene-1,4-diyl, cycloheptene-1,2-diyl or cyclo-octylene-1,2-diyl.

C₅-C₁₀ cycloalkyl-bis-(C₁-C₃ alkyl) is for example 1,2-bis(methylene)cyclopentane[=1,2-dimethylcyclopentane-1′,1″-diyl], 1,2-bis(methylene)cyclohexane[=1,2-dimethylcyclohexane-1′,1″-diyl], 1,3-bis(methylene)cyclohexane[=1,3-dimethylcyclohexane-1,1″-diyl], 1,4-bis(methylene)cyclohexane[=1,4-dimethylcyclohexane-1′,1″-diyl], 1,2-bis(methylene)cycloheptane or 1,5-bis(methylene)cyclooctane.

C₆-C₁₀ aryl-bis-(C₁-C₃ alkyl) is for example 1,2-bis(methylene)benzene[=ortho-xylene=1,2-dimethylbenzene-1′,1″-diyl], 1,3-bis(methylene)benzene[=meta-xylene], 1,4-bis(methylene)benzene [=para-xylene], 1,5-bis(methylene)naphthalene or 2,6-bis(methylene)naphthalene.

C₆-C₁₀ arylene is for example 1,2-phenylene, 1,3-phenylene, 1,4-phenylene, 2-methylphenyl-1,3-ene, 2-methylphenyl-1,4-diyl, naphthalene-1,5-diyl, napthalene-2,6-diyl or napthalene-1,8-diyl.

Dicarboxylic acids can also be partly or completely in their cyclic anhydride form, if a 5- or 6-atom ring formation is sterically possible.

Aminocarboxylic acids of formula (III) can also be partly or completely in the form of their corresponding lactam form of formula (III-r), if a 3-, 4-, 5-, 6- or 7-atom ring formation is possible.

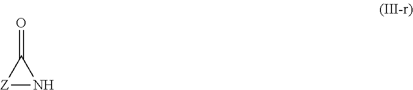

An aliphatic polyamide is defined herein as a polyamide, which is obtainable from a polycondensation, wherein in a compound of formula (I), X does not contain an aryl moiety, and in a compound of formula (II), Y does not contain an aryl moiety, or wherein in a compound of formula (III), Z does not contain an aryl moiety. In the case of an aliphatic polyamide, which is obtainable from polycondensation of a compound of formula (I), a compound of formula (II) and a compound of formula (III), an aryl moiety is accordingly not contained in any of X, Y or Z.

An aromatic polyamide is defined herein as a polyamide, which is obtainable from a polycondensation, wherein in a compound of formula (I), X contains an aryl moiety or in a compound of formula (II), Y contains an aryl moiety, or wherein in a compound of formula (III), Z contains an aryl moiety. In the case of an aromatic polyamide, which is obtainable from polycondensation of a compound of formula (I), a compound of formula (II) and a compound of formula (III), an aryl moiety is accordingly contained in at least one of X, Y or Z.

Examples for aliphatic polyamides are
polyamide-4 (polycondensation of a compound of formula III with Z=1,3-propylene), polyamide-6 (polycondensation of a compound of formula III with Z=1,5-pentylene), polyamide-10 (polycondensation of a compound of formula III with Z=1,9-nonylene), polyamide-11 (polycondensation of a compound of formula III with Z=1,10-decylene), polyamide-12 (polycondensation of a compound of formula III with Z=1,11-undecylene),
polyamide-4.6 (polycondensation of a compound of formula I with X=1,4-butylene and of a compound of formula II with Y=1,4-butylene), polyamide-6.6 (polycondensation of a compound of formula I with X=1,6-hexylene and of a compound with formula II with Y=1,4-butylene)[=polyhexamethyleneadipinamide], polyamide-6.10 (polycondensation of a compound of formula I with X=1,6-hexylene and of a compound with Y=1,8-octylene)[=polyhexamethylenesebacinamide], polyamide-6.12 (polycondensation of a compound of formula I with X=1,6-hexylene and of a compound with X=1,10-decylene)[=polyhexamethylenedodecanamide], polyamide-12.12 (polycondensation of a compound of formula I with X=1,12-dodecylene and of a compound of formula II with Y=1,10-decylene),
polyamide-6.6/6 (polycondensation of a compound of formula I with X=1,6-hexylene [=hexane-1,6-diamine], of a compound of formula II with Y=1,4-butylene [=adipic acid] and of a compound of formula III with Z=1,5-pentylene [=ε-caprolactam]), polyamide-6.10/6 (polycondensation of a compound of formula I with X=1,6-hexylene[=hexane-1,6-diamine], of a compound of formula II with Y=1,8-octylene[=decanedioic acid] and of a compound of formula III with Z=1,5-pentylene[=ε-caprolactam]), polyamide-6.12/6 (polycondensation of a compound of formula I with X=1,6-hexylene[=hexane-1,6-diamine], of a compound of formula II with Y=1,10-decylene[=1,12-dodecanedioic acid] and of a compound of formula III with Z=1,5-pentylene[=ε-caprolactam]), polyamide-6.6/6 (80:20) (polycondensation of a compound of formula I with X=1,6-hexylene [=hexane-1,6-diamine], of a compound of formula II with Y=1,4-butylene [=adipic acid] and of a compound of formula III with Z=1,5-pentylene [=ε-caprolactam], wherein the molar ratio of compound of formula I: compound of formula II: compound of formula III=80:80:20).

Examples for aromatic polyamides are
a polyamide, which is obtainable from the polycondensation of a compound of formula I with X=1,3-(methylene)benzene[=m-xylenediamine] and of a compound of formula II with Y=1,4-butylene[=adipic acid]
a polyamide, which is obtainable from the polycondensation of a compound of formula I with X=1,6-hexylene[=hexamehtylenediamine] and a compound of formula II with Y=1,3-phenylene[=isophthalic acid]
a polyamide, which is obtainable from the polycondensation of a compound of formula I with X=1,6-hexylene[=hexamethylenediamine] with a compound of formula II with Y=1,4-phenylene[=terephthalic acid]
a polyamide, which is obtainable from the polycondensation of a compound of formula I with X=2,4,4-trimethyl-hexyl-1,6-diyland of a compound of formula II with Y=1,3-phenylene [=isophthalic acid]
a polyamide, which is obtainable from the polycondensation of a compound of formula I with X=2,4,4-trimethyl-hexyl-1,6-diyland of a compound of formula II with Y=1,4-phenylene[=terephthalic acid]

Preferred is a method for manufacturing of a stabilized polyamide-containing composition, wherein the polyamide is an aliphatic polyamide.

Preferred is a method for manufacturing of a stabilized polyamide-containing composition, wherein the polyamide is a thermoplastic, aliphatic polyamide.

Preferred is a method of manufacturing of a stabilized polyamide-containing composition, wherein the polyamide is an aliphatic polyamide, which is obtainable
from polycondensation of a diamine of formula (I)

H₂N—X—NH₂ (I),
wherein
X is C₂-C₁₂ alkylene, C₅-C₁₂ cycloalkylene or C₅-C₁₀ cycloalkyl-bis-(C₁-C₃ alkyl);
and of a dicarboxylic acid of formula (II)

HOOC—Y—COOH (II),
wherein
X is C₂-C₁₂ alkylene, C₅-C₁₂ cycloalkylene or C₅-C₁₀ cycloalkyl-bis-(C₁-C₃ alkyl);
wherein the molar ratio between a diamine of formula (I) and a dicarboxylic acid of formula (II) is close to 1;
from polycondensation of an aminocarboxylic acid of formula (III),

H₂N—Z—COOH (III)
wherein
Z is C2-C₁₂ alkylene, C₅-C₁₂ cycloalkylene or C₅-C₁₀ cycloalkyl-bis-(C₁-C₃ alkyl);
or
from polycondensation of a diamine of formula (I), a dicarboxylic acid of formula (II) and an aminocarboxylic acid of formula (III);
wherein the molar ratio between a diamine of formula (I) and a dicarboxylic acid of formula (II) is close to 1.

Preferred is a method of manufacturing of a stabilized polyamide-containing composition, wherein the polyamide is an aliphatic polyamide, which is obtainable
from polycondensation of a diamine of formula (I)

H₂N—X—NH₂ (I),
wherein
X is 1,6-hexylene;
and of a dicarboxylic acid of formula (II)

HOOC—Y—COOH (II),
wherein
X is C₂-C₁₂ alkylene, C₅-C₁₂ cycloalkylene or C₅-C₁₀ cycloalkyl-bis-(C₁-C₃ alkyl);
wherein the molar ratio between a diamine of formula (I) and a dicarboxylic acid of formula (II) is close to 1;
from polycondensation of an aminocarboxylic acid of formula (III),

H₂N—Z—COOH (III)
wherein
Z is 1,6-hexylene;
or
from polycondensation of a diamine of formula (I), a dicarboxylic acid of formula (II) and an aminocarboxylic acid of formula (III);
wherein the molar ratio between a diamine of formula (I) and a dicarboxylic acid of formula (II) is close to 1.

Preferred is a method for manufacturing of a stabilized polyamide-containing composition, wherein the polyamide is an aliphatic polyamide and is polyamide-6, polyamide11, polyamide-6.6, polyamide-6.10, polyamide-6.12, polyamide-6.6/6, polyamide-6.10/6 or polyamide-6.12/6.

A further embodiment of this invention is a stabilized polyamide-containing composition, which contains at least 20% polyamide and which is obtainable by a method for manufacturing of a stabilized polyamide-containing composition, which contains at least 20% by weight of polyamide, which comprises the steps of
incorporating of a metal organic framework,
   which is a copper-based metal organic framework comprising
   metal ions, which are copper(II)-ions, and
   a C₆-C₂₄ aromatic hydrocarbon, which is substituted with at least two carboxylate groups,
   wherein two of the at least two carboxylate groups are forming coordinative bonds to the metal ions,
into a polyamide-containing composition, which contains at least 20% by weight of polyamide, to obtain a mixture for molding; and
heating of the obtained mixture for molding comprising the polyamide-containing composition and the metal organic framework to a temperature between 170° C. and 380° C.

For the stabilized polyamide-containing composition, the preferences for the method of manufacturing apply equally.

A further embodiment of this invention is a shaped article, especially a fiber, which contains a stabilized polyamide-containing composition. The shaped article can be a shaped final article, wherein the stabilized polyamide-containing composition is in a shape as finally desired, or a shaped intermediate composite, wherein the stabilized polyamide-containing composition is in a shape, which is beneficial for a further processing.

For the shaped article, the preferences for the method of manufacturing apply equally.

A physical form of the shaped intermediate composite is for example a pellet, a granulate or—after grinding—a powder.

The stabilized polyamide-containing composition can be advantageously used for various shaped articles, which are shaped final articles. Examples for such a shaped final article are:

I-1) Floating devices, marine applications, pontoons, buoys, plastic lumber for decks, piers, boats, kayaks, oars or beach reinforcements.

I-2) Automotive applications, in particular bumpers, dashboards, battery, rear and front linings, moldings parts under the hood, hat shelf, trunk linings, interior linings, air bag covers, electronic moldings for fittings (lights), panes for dashboards, instrument panel, exterior linings, upholstery, automotive lights, interior and exterior trims; door panels; gas tank; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, hinges, lock systems, luggage/roof racks, pressed/stamped parts, seals, side impact protection, sound deadener/insulator or sunroof.

I-3) Road traffic devices, in particular sign postings, posts for road marking, car accessories, warning triangles, medical cases, helmets or tires.

II-1) Appliances, cases and coverings in general and electric/electronic devices (personal computer, telephone, portable phone, printer, television-sets, audio and video devices), flower pots, satellite TV bowl or panel devices.

II-2) Jacketing for other materials such as steel.

II-3) Devices for the electronic industry, in particular insulation for plugs, especially computer plugs, cases for electric and electronic parts, printed boards or materials for electronic data storage.

II-4) Applications in wire and cable (semi-conductor, insulation or cable-jacketing).

II-5) Foils for condensers, refrigerators, heating devices, air conditioners, encapsulating of electronics, semi-conductors, coffee machines or vacuum cleaners.

III-1) Technical articles such as cogwheel (gear), slide fittings, spacers, screws, bolts, handles or knobs.

III-2) Rotor blades, ventilators and windmill vanes, solar devices, pool liners, pond liners, closets, wardrobes, dividing walls, slat walls, folding walls, roofs, shutters (e.g. roller shutters), fittings, connections between pipes, sleeves or conveyor belts.

III-3) Pipes (cross-linked or not) for water, waste water and chemicals, pipes for wire and cable protection, pipes for gas, oil and sewage, guttering, down pipes or drainage systems.

III-6) Profiles of any geometry (window panes) or siding.

III-7) Glass substitutes, in particular extruded or co-extruded plates, glazing for buildings (monolithic, twin or multiwall), aircraft, schools, extruded sheets, window film for architectural glazing, train, transportation, sanitary articles or greenhouse.

III-8) Plates (walls, cutting board), silos, wood substitute, plastic lumber, wood composites, walls, surfaces, furniture, decorative foil, floor coverings (interior and exterior applications), flooring, duck boards or tiles.

III-9) Intake or outlet manifolds.

III-10) Cement-, concrete-, composite-applications and covers, siding and cladding, hand rails, banisters, kitchen work tops, roofing, roofing sheets, tiles or tarpaulins.

III-11) Tapes or ropes.

IV-1) Woven fabrics continuous and staple, fibers (carpets/hygienic articles/geotex-tiles/monofilaments; filters; wipes/curtains (shades)/medical applications), bulk fibers (applications such as gown/protection clothes), nets, ropes, cables, strings, cords, threads, safety seat-belts, clothes, underwear, gloves; boots; rubber boots, intimate apparel, garments, swimwear, sportswear, umbrellas (parasol, sunshade), parachutes, paraglides, sails, “balloon-silk”, camping articles, tents, airbeds, sun beds, bulk bags or bags.

IV-2) Non-woven fabrics such as medical fabrics and related apparel, industrial apparel, outdoor fabrics, in-home furnishing or construction fabrics.

IV-3) Membranes, insulation, covers and seals for roofs, tunnels, dumps, ponds, dumps, walls roofing membranes, geomembranes, swimming pools, curtains (shades)/sun-shields, awnings, canopies, wallpaper, food packing and wrapping (flexible and solid), medical packaging (flexible & solid), airbags/safety belts, arm- and head rests, carpets, centre console, dashboard, cockpits, door, overhead console module, door trim, headliners, interior lighting, interior mirrors, parcel shelf, rear luggage cover, seats, steering column, steering wheel or trunk trim.

V) Films (packaging, dump, laminating, agriculture and horticulture, greenhouse, mulch, tunnel or silage).

VI-1) Food packing and wrapping (flexible or solid) or bottles.

VI-2) Storage systems such as boxes (crates), luggage, chest, household boxes, pallets, shelves, tracks, screw boxes, packs or cans.

VI-3) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices or packing for pharmaceuticals blister.

VII-1) Extrusion coating (photo paper, tetrapack, pipe coating), household articles of any kind (e.g. appliances, thermos bottle/clothes hanger), fastening systems such as plugs, wire and cable clamps, zippers, closures, locks or snap-closures.

VII-2) Support devices, articles for the leisure time such as sports and fitness devices, gymnastics mats, ski-boots, inline-skates, skis, big foot, athletic surfaces (e.g. tennis grounds); screw tops, tops and stoppers for bottles or cans.

VII-3) Furniture in general, foamed articles (cushions, impact absorbers), foams, sponges, dish clothes, mats, garden chairs, stadium seats, tables, couches, toys, building kits (boards/figures/balls), playhouses, slides or play vehicles.

VII-4) Kitchen ware (eating, drinking, cooking or storing).

VII-5) Boxes for CD's, cassettes and video tapes; DVD electronic articles, office supplies of any kind (ball-point pens, stamps and ink-pads, mouse, shelves, tracks) or bottles of any volume and content (drinks, detergents, cosmetics including perfumes).

VII-6) Footwear (shoes/shoe-soles), insoles, spats, adhesives, structural adhesives or food boxes (fruit, vegetables, meat, fish).

Preferred is a shaped article, especially a final shaped article, which is a film, a pipe, a profile, a bottle, a tank, a container or a fiber. A fiber is especially preferred.

Preferred is a shaped article, especially a shaped intermediate composite, which is in the physical form of a pellet or a granulate.

Preferably, the weight content of the stabilized polyamide-containing composition at the the shaped article is above 80%, in particular above 95%.

A further embodiment of this invention is the use of a metal organic framework, which is a copper-based metal organic framework comprising
metal ions, which are copper(II)-ions, and
a C₆-C₂₄ aromatic hydrocarbon, which is substituted with at least two carboxylate groups,
wherein two of the at least two carboxylate groups are forming coordinative bonds to the metal ions,
   for stabilizing, especially providing durability for, a stabilized polyamide-containing composition, which contains at least 20% by weight of polyamide, against degradation by heat, light or oxygen.

For the use of a metal organic framework, the preferences for the method of manufacturfing apply equally.

Preferred is the use for stabilizing against degradation by heat, in particular a stabilization under long-term exposure of heat. Long-term is herein understood as more than 1 hour, especially more than 1 day.

Preferred is the use for providing durability against degradation by heat, in particular a provision of durability under long-term exposure of heat.

A further embodiment of this invention is a mixture for molding, which comprises
a) a polyamide-containing composition, which contains at least 20% by weight of polyamide, and
b) a metal organic framework, which is a copper-based metal organic framework comprising
   metal ions, which are copper(II)-ions, and
   a C₆-C₂₄ aromatic hydrocarbon, which is substituted with at least two carboxylate groups,
   wherein two of the at least two carboxylate groups are forming coordinative bonds to the metal ions,
      wherein the content of the polyamide is at least 20% by weight of the mixture, and the mixture has not been heated to a temperature above 160° C.

For the mixture of molding, the preferences of the method for manufacturing are valid equally if applicable.

Preferred is a mixture for molding, which comprises
c) a further component, which is another stabilizer, another polymer, a colorant, a filler, a flame retardant, a nucleating agent or a processing aid.

A further embodiment of this invention is a masterbatch preparation of a mixture for molding. The masterbatch preparation of a mixture for molding is a mixture for molding, wherein the content of the metal organic framework in a polyamide-containing composition is above 3% and up to 25%. The masterbatch preparation is a concentrated trade form, which is relevant, if the mixture for molding is separately prepared. It allows an economic transport, storage and a simplified dosing. It is dosed and thus practically diluted during the method for manufacturing of the stabilized polyamide-containing composition to equal the incorporation of a metal organic framework in an amount of 0.003% and 3% based on the weight of the polyamide in the polyamide-containing composition.

For the masterbatch preparation of a mixture for molding, the preferences of the method for manufacturing are valid equally if applicable.

The technical effects and technical problems in this description are exemplary and not limiting. It should be noted that the embodiments described in this description may have other technical effects and can solve other technical problems.

Compound (101) is known for example from Stephen S.-Y. Chui et al., Science, 1999, vol. 283, p. 1148-1150. A CAS-number of compound (101) is [51937-85-0] and it is also contained in Basolite C300 (RTM, BASF). Synthetic accesses are described in US-A-2009/0042000 and in US-A-2007/0227898, wherein the latter one is based on electrochemistry. Basolite C300 can be activated at 140° C. for 13 hours to remove water if an anhydrous form is desired.

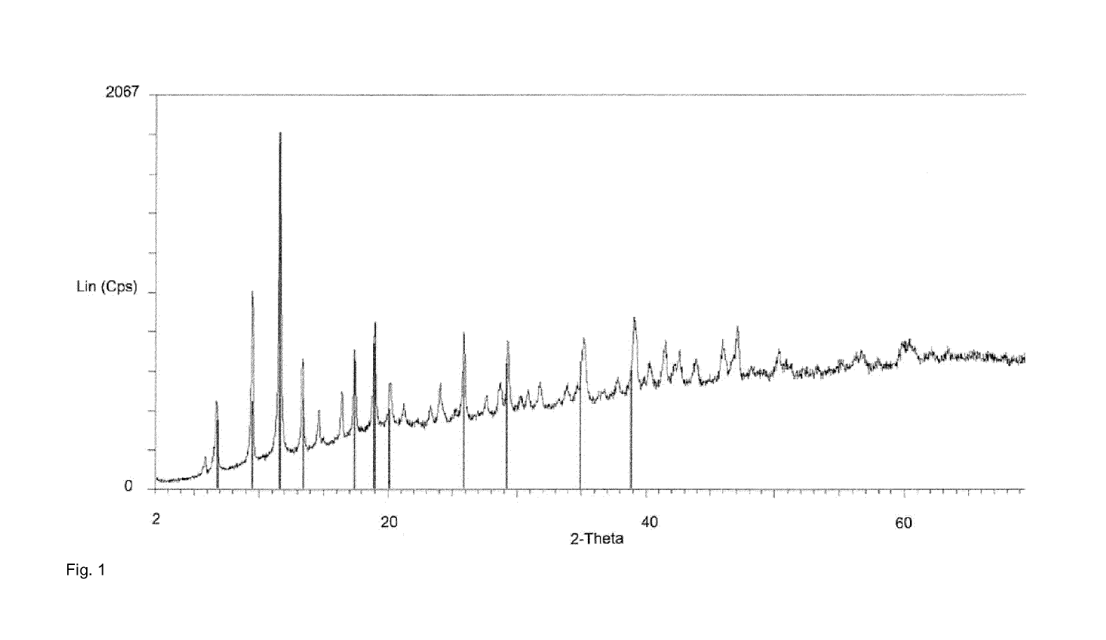

FIG. 1: X-ray diffraction spectra of compound (101)

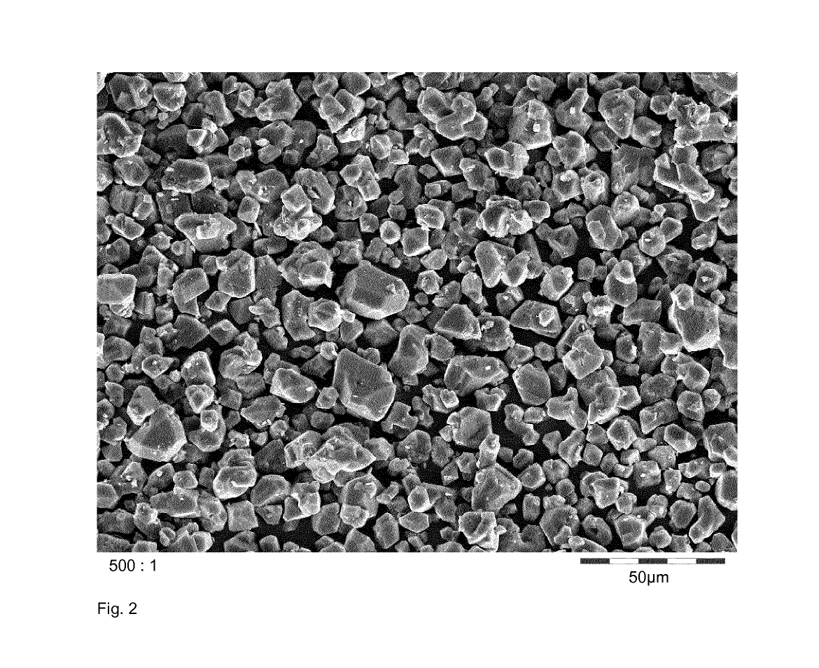

FIG. 2: Scanning electron microscope picture of compound (101) at amplification of 500:1

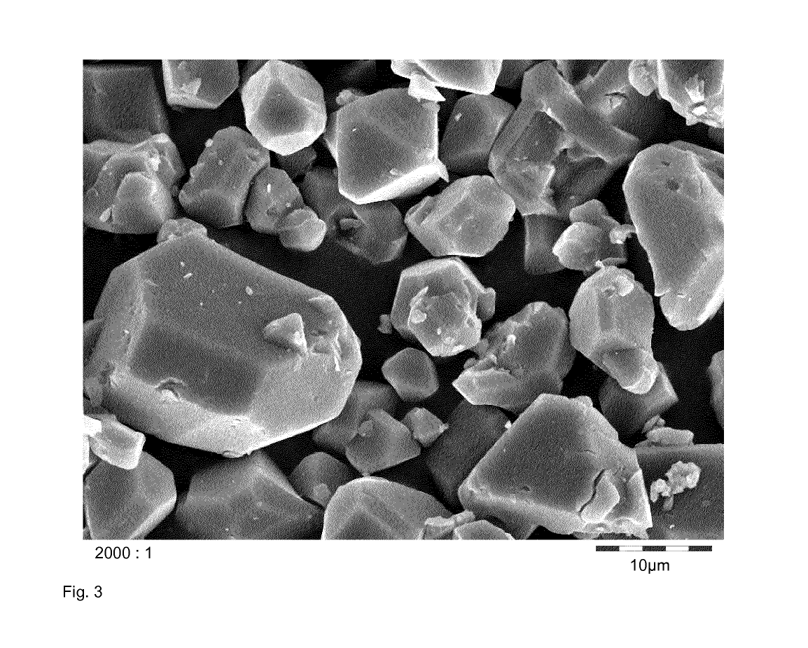

FIG. 3: Scanning electron microscope picture of compound (101) at amplification of 2000:1

The following examples illustrate further the invention without limiting it. If not stated to the contrary, percentage values refer to weight.

### EXAMPLE 1

### Preparation of Compound (101)

Compound (101) is prepared as described in US-A-2009/0042000 at example 4, i.e. 150 kg of anhydrous CuSO4 were suspended together with 71 kg of 1,3,5-benzene-tricarboxylic acid in 2200 kg of ethylene glycol and blanketed with N2. The vessel is brought to 110° C. and the synthesis mixture was kept at this temperature for 15 h with stirring. The solution is filtered at 110° C. under N2 blanketing with a pressure filter. The filtercake is washed with 2×200 L of methanol and 3×240 L of methanol with stirring. The product is subsequently dried in vacuum at 104° C. for 10 h. The yield is 61.1 kg. The BET surface area according to DIN66131 is 1517 m²/g.

The X-ray diffraction diagram of compound (101) (measured with Cu Kα/displayed in FIG. 1) shows characteristic lines and relative intensities. Lines with a relative intensity above 10% (determined without a deduction of the background) are depicted in table 1.

TABLE 1

| | angle 2-theta | d value | intensity |
|---|---|---|---|
| line no. | [°] | [Angstrom] | [%] |
| 1 | 6.76 | 13.07 | 38 |
| 2 | 9.52 | 9.29 | 29 |
| 3 | 11.68 | 7.57 | 100 |
| 4 | 13.46 | 6.57 | 15 |
| 5 | 14.67 | 6.03 | 12 |
| 6 | 16.50 | 5.37 | 11 |
| 7 | 17.52 | 5.06 | 23 |
| 8 | 19.06 | 4.65 | 20 |
| 9 | 20.24 | 4.38 | 15 |
| 10 | 25.98 | 3.43 | 13 |
| 11 | 29.38 | 3.04 | 17 |
| 12 | 35.24 | 2.54 | 18 |
| 13 | 39.17 | 2.30 | 18 |
| 14 | 40.37 | 2.23 | 11 |
| 15 | 41.58 | 2.17 | 16 |
| 16 | 42.30 | 2.13 | 12 |
| 17 | 42.73 | 2.11 | 13 |
| 18 | 43.94 | 2.06 | 11 |
| 19 | 46.10 | 1.97 | 15 |
| 20 | 46.80 | 1.94 | 12 |
| 21 | 47.19 | 1.92 | 15 |
| 22 | 50.41 | 1.81 | 12 |
| 23 | 56.36 | 1.63 | 11 |
| 24 | 56.76 | 1.62 | 11 |
| 25 | 60.04 | 1.54 | 12 |
| 26 | 60.48 | 1.53 | 12 |

Particle distribution is determined with a Malvern Mastersizer (S Ver. 2.15) Particle Size Analyzer in analogy to IS013320. The Malvern Mastersizer records the light pattern scattered from a field of particles at different angles. An analytical procedure is then used to determine the size distribution of spherically shaped particles that created the patterns. The result of the analysis is the relative distribution of volume (number) of particles in the range of size classes. Measurement parameters are: obscuration—1.6%; concentration—0.002% vol; scattering model—Fraunhofer; analysis model—polydisperse; suppressed channels—<0.49 μm, >163.77 μm. The particles sizes are: D(v,0.1)=24 μm, D(v,0.5)=44 μm, D(v,0.9)=70 μm, D[4,3]=46 μm and D[3,2]=37 μm.

The idealized empirical formula of the formal monomer of compound (101) is [Cu₃(1,3,5-benzene-tricarboxylate)₂]/C₁₈H₆O₁₂Cu₃ with a molecular weight of 604.9 g/mol and a copper weight-content of 31.5%.

Elemental analysis:

| | | | |
|---|---|---|---|
| calc. C | 35.7% | found C | 35.2% |
| calc. Cu | 31.5% | found Cu | 30.2% |

Small traces of humidity at compound (101) are already enough to change color from dark blue over medium blue to pale blue.

### EXAMPLE 2

### Compound (101) in Filter Pressure Value Test

A sample of compound (101) is subjected to a screen pack test according to EN13900-5 that issued to determine fiber suitability of particulates and the standard filter test is run as if compound (101) is a pigment.

Hence, 12 g of compound (101) is mixed with 18 g Licowax (RTM Clariant, polyethylene wax) in an 8 ounce (=227 g) glass jar. The mixture is then heated until the wax melts, mixed with a spatula, and cooled. The mixture is removed and crushed. The crushed mixture is added to an adiabatic mixer with an internal rotating blade and fluxed at 3000 rpm for three minutes. The hot mix is removed and placed on an aluminium sheet until cool after which it is crushed again.

12.5 grams of the above mixture is combined with 187.5 grams of Basell HL232 polypropylene resin (RTM LyondellBasell) and thoroughly mixed at room temperature. This mixture is fed into a Dr Collin single screw extruder which meets the standards of EN13900-5 for screw type, diameter, and length and also which has in place a melt pump, breaker plate and screen according to the guidelines. The screen used is coded PX25L and referred to as Screen-pack 1 in section 6.6.2 of the standard (two layer construction, with the important screen being the 615/108 reverse plain Dutch weave of wire diameters 0.042 mm/0.14 mm). The temperatures are uniformly set to 230° C. for the extrusion step.

The pressure on the melt pump is set and controlled to 50 bar (=5000 kPa) and the melt flow rate is set to 39.2 to 41.3 grams per minute by adjusting the melt pump rotation speed. Pressure is measured at the screen and tracked over the time of the test which is 8 minutes. The pressure difference between and start of the test and the end of the test is a measure of the number/size of oversize particles which reduce the flow area through the screen.

For compound (101), the pressure on the screen rose from 10.8 bar (=1080 kPa) to 15.4 bar (=1540 bar) over the time of the test yielding an acceptable result for fiber application of 0.9 bar (=90 kPa) per gram of the compound passing through the screen.

### EXAMPLE 3

### Preparation of Polyamide Fibers

The employed materials are Ultramid B27 (RTM BASF, polyamide 6, melting point 220° C., amino end groups 37+/−2 meq/kg, pellets of 2×2.5 [mm] size), compound (101) from example 1, KI (potassium iodide of polymer grade), KBr (potassium bromide of polymer grade) and a mixture of 80 parts of potassium iodide (KI), 10 parts CuI (copper(I) iodide) and 10 parts zinc stearate.

The initial compositions prior to extrusion are stated in parts per weight in table 2. The copper content of composition No. 3 is calculated with 33.4% Cu content for copper(I) iodide, whereas compound (101) is taken in calculation with 31.5% Cu content.

TABLE 2

| Compo- | | com- | | | | Zn | calcu- |
|---|---|---|---|---|---|---|---|
| sition | Ultramid | pound | | | | stea- | lated Cu |
| No. | B27 | (101) | CuI | KI | KBr | rate | content |
| 1 ^{a)} | 100 | — | — | — | — | — | 0 ppm |
| 2 ^{a)} | 100 | — | — | 0.265 | — | — | 0 ppm |
| 3 ^{a)} | 100 | — | 0.033 | 0.264 | — | 0.033 | 110 ppm |
| 4 ^{b)} | 100 | 0.0322 | — | — | — | — | 101 ppm |
| 5 ^{b)} | 100 | 0.0323 | — | 0.265 | — | — | 101 ppm |
| 6 ^{b)} | 100 | 0.0323 | — | — | 0.265 | — | 101 ppm |

^{a)} comparative
^{b)} inventive

The single components are mixed at room temperature, with the exception that the CuI/KI/zinc stearate of composition No. 3 is added already premixed to the polyamide, and afterwards fed for compounding into in a co-rotating twin screw extruder with venting (Leistritz ZSE 27 mm, screen pack 20/100/20, barrel sections are set to temperatures 200/210/220/230/230/230/230/230° C., residence time 41 sec., 200 rounds per minute, feeder speed 8.2). The extruded strand is cooled in a water bath and cut to obtain pellets. The compounded pellets are cooled and collected.

The obtained compounded pellets are fed into a Hills R&D spine line. The spinneret is a 36 round hole, the residence time is 3:45 min, the calculated fiber speed is 29.2 g/min, zones 1 to 4 are set to 232/241/243/254° C. and the spin head to 268° C., and the the draw ratios are around 2.60+/−0.02. Polyamide fibers are obtained.

### EXAMPLE 4

### Yellowness Index of Obtained Polyamide Fibers

The fibers obtained in example 3 are not textured and wound flat on white cards to a depth of 1 mm and measured with a Konica Minolta integrating sphere spectrophotometer CM 3600D Colibri (light source: D 6500, observer: 10 degree, large area view of 30 mm, UV400, calculations after CIELab 1976) to determine the yellowness index according to ASTM E31384. The results are listed in table 3.

TABLE 3

| | obtained | | | | | | |
|---|---|---|---|---|---|---|---|
| | from compo- | | | | | | |
| fiber sample | sition No. | L* | a* | b* | C* | h⁰ | YI |
| fiber-1 ^{a)} | 1 ^{a)} | 93.0 | −1.1 | 6.7 | 6.8 | 99.2 | 10.1 |
| fiber-2 ^{a)} | 2 ^{a)} | 91.0 | −1.0 | 8.2 | 8.3 | 96.8 | 12.6 |
| fiber-3 ^{a)} | 3 ^{a)} | 90.0 | −2.1 | 6.8 | 7.1 | 107.4 | 10.5 |
| fiber-4 ^{b)} | 4 ^{b)} | 91.3 | −1.5 | 5.2 | 5.4 | 106.1 | 8.0 |
| fiber-5 ^{b)} | 5 ^{b)} | 90.5 | −2.5 | 10.2 | 10.5 | 103.6 | 15.5 |
| fiber-6 ^{b)} | 6 ^{b)} | 91.2 | −1.5 | 5.1 | 5.3 | 106.0 | 8.0 |

Footnotes at table 2

It is shown that compound (101) alone as well as compound (101) in combination with potassium bromide result in the lowest yellowness index, whereas potassium iodide containing compositions result in unfavorable higher yellowness index.

### EXAMPLE 5

### Elongation and Tenacity Retention After Dry Xenon Exposure

The fibers obtained in example 3 are submitted to dry xenon exposure according to AATCC 16-2004 (option 3, irradiance 0.41 W/m², wavelength 340 nm, black panel temperature 63° C., cycle: continuous light and no spray, filters: soda lime outer, borosilicate inner). The measured tensile strain at break (%) with the resulting retention (%) of elongation is depicted in table 4. The measured tenacity at break (gf/den) with the resulting retention of tenacity (%) is depicted in table 5.

TABLE 4

| fiber sample | | | | | | | |
|---|---|---|---|---|---|---|---|
| (- out of | | | | | | | retention of |
| composi- | 0 | 100 | 200 | 300 | 835 | 1550 | elongation |
| tion No.) | hr | hr | hr | hr | hr | hr | (1550 hr) |
| fiber-1 ^{a)} | 94.10 | 66.80 | 16.00 | 6.30 | 0.00 | 0.00 | 0% |
| fiber-2 ^{a)} | 156.90 | 126.40 | 98.00 | 90.20 | 70.00 | 48.30 | 31% |
| fiber-3 ^{a)} | 96.50 | 86.60 | 74.30 | 82.90 | 54.20 | 28.20 | 29% |
| fiber-4 ^{b)} | 170.40 | 98.90 | 100.50 | 85.90 | 64.40 | 52.80 | 31% |
| fiber-5 ^{b)} | 182.00 | 146.10 | 145.60 | 113.40 | 85.10 | 79.20 | 44% |
| fiber-6 ^{b)} | 165.20 | 135.30 | 148.80 | 126.50 | 78.20 | 48.40 | 29% |

Footnotes at table 2

TABLE 5

| fiber sample | | | | | | | |
|---|---|---|---|---|---|---|---|
| (- out of | | | | | | | retention of |
| composi- | 0 | 100 | 200 | 300 | 835 | 1550 | tenacity |
| tion No.) | hr | hr | hr | hr | hr | hr | (1550 hr) |
| fiber-1 ^{a)} | 1.30 | 1.00 | 0.70 | 0.40 | 0.00 | 0.00 | 0% |
| fiber-2 ^{a)} | 1.30 | 1.20 | 1.10 | 0.80 | 1.00 | 0.70 | 54% |
| fiber-3 ^{a)} | 1.10 | 1.20 | 1.10 | 1.10 | 0.90 | 0.80 | 73% |
| fiber-4 ^{b)} | 1.20 | 1.00 | 1.10 | 0.90 | 0.80 | 0.80 | 67% |
| fiber-5 ^{b)} | 1.30 | 1.40 | 1.40 | 1.30 | 0.90 | 0.90 | 69% |
| fiber-6 ^{b)} | 1.10 | 1.20 | 1.20 | 1.20 | 0.90 | 0.70 | 64% |

Footnotes at table 2

The results show that compound (101) alone achieves retention values of elongation and tenacity under dry xenon exposure, which are in the same range as those of combinations with a potassium halide.

### EXAMPLE 6

### Elongation and Tenacity Retention After Wet Xenon Exposure

The fibers obtained in example 3 are submitted to wet xenon exposure according to ISO 4892-2 (cycle 1, irradiance 0.51 W/m², wavelength 340 nm, black std temperature 65° C., cycle: 102 minutes of light—18 minutes of light and water spray, filters: daylight). The measured tensile strain at break (%) with the resulting retention (%) of elongation is depicted in table 6. The measured tenacity at break (gf/den) with the resulting retention of tenacity (%) is depicted in table 7.

TABLE 6

| fiber sample | | | | | | |
|---|---|---|---|---|---|---|
| (- out of | | | | | | retention of |
| composi- | 0 | 200 | 500 | 700 | 1520 | elongation |
| tion No.) | hr | hr | hr | hr | hr | (1520 hr) |
| fiber-1 ^{a)} | 94.10 | 25.90 | 0.00 | 0.00 | 0.00 | 0% |
| fiber-2 ^{a)} | 156.90 | 68.40 | 35.30 | 29.80 | 0.00 | 0% |
| fiber-3 ^{a)} | 96.50 | 64.90 | 50.70 | 42.90 | 20.40 | 21% |
| fiber-4 ^{b)} | 170.40 | 97.40 | 59.70 | 49.20 | 25.30 | 15% |
| fiber-5 ^{b)} | 182.00 | 75.10 | 78.90 | 53.40 | 30.50 | 17% |
| fiber-6 ^{b)} | 165.20 | 72.40 | 64.60 | 55.10 | 28.40 | 17% |

Footnotes at table 2

TABLE 7

| fiber sample | | | | | | |
|---|---|---|---|---|---|---|
| (- out of | | | | | | retention of |
| composi- | 0 | 200 | 500 | 700 | 1520 | tenacity |
| tion No.) | hr | hr | hr | hr | hr | (1520 hr) |
| fiber-1 ^{a)} | 1.30 | 0.90 | 0.00 | 0.00 | 0.00 | 0% |
| fiber-2 ^{a)} | 1.30 | 1.00 | 0.60 | 0.80 | 0.00 | 0% |
| fiber-3 ^{a)} | 1.10 | 1.00 | 0.90 | 0.90 | 0.60 | 55% |
| fiber-4 ^{b)} | 1.20 | 1.40 | 0.80 | 0.80 | 0.70 | 58% |
| fiber-5 ^{b)} | 1.30 | 1.00 | 1.00 | 0.90 | 0.80 | 62% |
| fiber-6 ^{b)} | 1.10 | 1.00 | 0.90 | 0.80 | 0.70 | 64% |

Footnotes at table 2

The results show that compound (101) alone achieves retention values of elongation and tenacity under dry xenon exposure, which are in the same range as those of combinations with a potassium halide.

1. A method for manufacturing a stabilized polyamide-containing composition comprising at least 20% by weight of a polyamide the method comprising:
incorporating a metal organic framework into a polyamide-containing composition to obtain a mixture; and
heating the mixture to a temperature between 170° C. and 380° C.;
wherein:
the metal organic framework is a copper-based metal organic framework comprising copper(II)-ions and a C₆-C₂₄ aromatic hydrocarbon substituted with at least two carboxylate groups where two of the at least two carboxylate groups form coordinative bonds to the copper(II)-ions,
the polyamide-containing composition comprises at least 20% by weight of the polyamide and
the mixture comprises at least 20% by weight of the polyamide.

2. The method according to claim 1, wherein each of the copper(II)-ions further bonds coordinatively to two carboxylate groups which are not located on the C₆-C₂₄ aromatic hydrocarbon.

3. The method according to claim 1, wherein: the two of the at least two carboxylate groups are separated by at least 3 carbon atoms of the C₆-C₂₄ aromatic hydrocarbon, with the proviso that the two of the at least two carboxylate groups form coordinative bonds to different copper(II)-ions.

4. The method according to claim 1, wherein the two of the at least two carboxylate groups are separated by at least 3 carbon atoms of the C₆-C₂₄ aromatic hydrocarbon, and are not able to form, in their free acid form under release of water, an intramolecular 6- or 7-membered cyclic anhydride.

5. The method according to claim 1, wherein the C₆-C₂₄ aromatic hydrocarbon is substituted with three carboxylate groups and is 1,3,5-benzene-tricarboxylate.

6. The method according to claim 1, wherein the copper-based metal organic framework has a specific surface area, determined in accordance with DIN 66135, of more than 5 m²/g.

7. The method according to claim 1, wherein the stabilized polyamide-containing composition contains at least 50% by weight of polyamide.

8. The method according to claim 1, wherein the heating is conducted in an extruder.

9. The method according to claim 1, wherein the metal organic framework is incorporated into the polyamide-containing composition in an amount between 0.003% and 3% based on the weight of the polyamide.

10. The method according to claim 1, wherein the incorporating further comprises incorporating a component into the polyamide-containing composition the component being selected from the group consisting of a stabilizer, a polymer, a colorant, a filler, a flame retardant, a nucleating agent and a processing aid.

11. The method according to claim 1, wherein the stabilized polyamide-containing composition has a ratio of an overall copper weight content to a halogen weight content, where the halogen is in form of a salt halide, of above 1.

12. The method according to claim 1, wherein the polyamide is an aliphatic polyamide and is selected from the group consisting of polyamide-6, polyamide-11, polyamide-6.6, polyamide-6.10, polyamide-6.12, polyamide-6.6/6, polyamide-6.10/6 and polyamide-6.12/6.

13. A stabilized polyamide-containing composition comprising at least 20% of an polyamide, obtained by the method according to claim 1.

14. A shaped article comprising the stabilized polyamide-containing composition according to claim 13.

15. The method according to claim 1, wherein the metal organic framework stabilizes the stabilized polyamide-containing composition against degradation by heat, light or oxygen.

16. A mixture suitable for molding, comprising:
a polyamide-containing composition comprising at least 20% by weight of a polyamide, and
a metal organic framework, which is a copper-based metal organic framework comprising:
copper(II)-ions, and
a C₆-C₂₄ aromatic hydrocarbon substituted with at least two carboxylate groups, where two of the at least two carboxylate groups form coordinative bonds to the copper(II)-ions,
wherein the mixture comprises at least 20% of the polyamide by weight of the mixture, and the mixture has not been heated to a temperature above 160° C.

17. A shaped article comprising the mixture according to claim 16.
